(19) United States
(12) Patent Application Publication
(10) Pub. No.: US 2018/0167426 A1
(43) Pub. Date: Jun. 14, 2018

(54) Multiplatform Screen Sharing Solution for Software Demonstration

(71) Applicant: CrankWheel ehf., Reykjavik (IS)

(72) Inventors: Jóhann Tómas Sigurdsson, Gardabaer (IS); Porgils Már Sigvaldason, Kópavogur (IS); Jóhann Eiríksson, Reykjavik (IS); Hordur Ragnarsson, Reykjavik (IS)

(73) Assignee: CrankWheel ehf.

(21) Appl. No.: 15/890,739

(22) Filed: Feb. 7, 2018

Related U.S. Application Data
(63) Continuation-in-part of application No. 15/337,853, filed on Oct. 28, 2016.
(60) Provisional application No. 62/455,777, filed on Feb. 7, 2017.
(60) Provisional application No. 62/248,159, filed on Oct. 29, 2015.

(51) Int. Cl. H04L 29/06; G06F 3/14

(52) U.S. Cl. CPC H04L 65/403; G06F 3/1454; H04L 65/1069

(57) ABSTRACT

A method of providing on-demand, live, presenter hosted, product or service demonstrations via the internet wherein a server connects a host device and viewer device to enable the host device to provide a real time screen sharing session via web browser wherein software can be demonstrated without the need for the viewing device to install any additional software.

### BACKGROUND OF THE INVENTION

The present subject matter relates generally to screen sharing software. More specifically, the present invention relates to screen sharing software that operates through a standard Internet browser without any additional software required.

Screen sharing is among one of the most useful tools in sales, customer service, IT help desk support, and any other industry in which it is valuable to be able to show others, in real-time, a local user's actions. In many instances, screen sharing applications are used so that the viewing parties may learn by watching. This type of learning, termed observational learning, is favored by many when learning unfamiliar topics.

While screen sharing is not new, establishing a screen sharing session is currently unnecessarily complex. Current solutions typically require both sides of a screen sharing session to install software, which takes time and can, in some cases, cost money. Additionally, given the wide range of computing devices currently in use (e.g., tablets, smartphones, laptops, desktop PCs, etc.), such software might not be available for some users' devices (e.g., iOS and Windows exclusives).

If users are able to obtain and install the proper software as required by current screen sharing solutions, such solutions generally use a numeric code for session viewers to enter the session. This code is typically long (9 digits); making it difficult to share over the phone and hard for session viewers to type in on the go. Additionally, if this code was given out to, or stolen by, unauthorized parties, anyone in the world with the proper software could join the screen sharing session and view the information being shared.

In addition to concerns about accessibility and security, current screen sharing solutions are also very clunky and difficult to use in a seamless way when presenting information to viewers. There is almost always lag or delay between what a host user is viewing on their actual screen and what viewers of the screen sharing session are shown. This delay requires the presenter to attempt to account for the delay by pacing their speech, etc. so viewers do not fall too far behind, but this too is difficult because the delay in what each side of a screen sharing session is viewing varies based on a multitude of factors including international network connections.

A different technology, called co-browsing, generally focuses on the host (e.g., a customer service agent) and the viewing parties examining and possibly manipulating the same web page concurrently. This technology, like screen sharing software, requires the use of long URLs or meeting codes to join a co-browsing session.

Additionally, co-browsing is usually implemented by putting what is effectively a user agent onto the Internet, having that user agent connect on behalf of both/all parties involved in the co-browsing session, and having both/all parties receive a version of the web page as seen by the user agent. This method of co-browsing is limited in many ways, for example: intranet pages cannot be shown (unless the user agent is placed on the intranet in question); login sessions of the co-browsers do not extend to the co-browsing user agent, requiring these users to log into secure websites, etc. again when co-browsing; and the shared view seen in a co-browsing session might not be 100% the same when viewed by different users due to issues in the implementation of such a solution.

Accordingly, there is a need for a multi-platform screen sharing solution, as described herein.

### BRIEF SUMMARY OF THE INVENTION

To meet the needs described above and others, the present disclosure provides a multiplatform screen sharing system.

In one embodiment, the multiplatform screen sharing system may consist of browser based client software and one or more centralized servers. The browser based client software utilized by the system may run on any number of client devices (e.g., tablets, smartphones, laptops, desktop computers, etc.) and be a standalone software application or an add-on to another software program (e.g., a Google Chrome Extension). In one embodiment, the browser based software is a Google Chrome browser extension that enables a HTML5 media stream to be generated from the current browser tab being viewed, the full screen a user is viewing, or for a particular program window. This browser extension may be programed via HTML, CSS, and/or JavaScript (or another programming language capable of creating a browser extension) and connects to the centralized system server(s) using a web protocol (e.g., HTTP(S) and/or WebSockets, when available).

The information sent by the browser based client software is received by one or more centralized servers. In some example, the servers are physically (or virtually) separate from each other. In other examples, the servers may be embodied in a single server in which different portions of the server carrying out different tasks. One such task is termed “reflection” which, in this context, means forwarding the information sent by the browser based client software to the end users. The end users include the host (e.g., the user or users sharing the screen; may also be referred to as the agent user) and the one or more viewers (e.g., the user or users who are viewing the shared screen; may also be referred to as the client user). The data sent by these users may be “reflected” or forwarded on by the centralized reflection servers, which help accommodate the processing and bandwidth required to share screen capture information over the web. The centralized servers also act to provision data and these provisional servers store information about end users, their location, as well as data on the geographical location, bandwidth, etc. of the reflection servers, which enables the system to detect which reflection servers should be utilized for a given screen sharing session. Worth noting is that, while host users need to install the browser based client software, viewers of a screen sharing session only need a standard web browser to view the session and communicate with a host user.

The system may also optimize the efficiency and stability of hosting screen sharing sessions through the use of several additional functions. One such function is the use of a connection handler module that handles establishing and authenticating a connection between a host user and at least one viewer. Each host and each viewer are assigned their own connection handler instance which forwards messages between users. The connection handler component of the system may be part of the reflection servers, the provisioning servers, or both, and allows users to communicate with only minimal information being written to the centralized server's databases. The connection handler module is particularly useful when a host user is sharing his or her screen with multiple users, as each user is assigned their own connection handler instead of having multiple users send and receive information from a single connection.

Another feature of the system that helps to optimize screen sharing stability and efficiency is the use of differential updates when sending screen capture information. When a host user is sharing a web browser tab, program window, or entire desktop, the amount of information sent to viewers can be immense. The present system limits the amount of data that must be transferred by tracking the changes from frame to frame of a shared screen. For instance, if a host user is an IT support person and is demonstrating to a viewer how to delete an item from the desktop, the host user would likely show the viewer how to drag the document to the recycling bin. Since the only things changing on the image of the shared screen are the document to be deleted and the recycling bin, other elements shown on the shared screen remain static. The data about these static elements therefore does not need to be resent from frame to frame and only the changed portions of the shared screen need to be updated. This use of differential updates by the system saves a good deal of bandwidth and allows for a more stable connection between host and viewer(s). The use of differential updates can also be applied to scrolling up and down a webpage, cursor movement, etc. and can also send frame updates less frequently when a there is little or no action occurring on the shared screen.

Yet another way in which the present system optimizes screen sharing efficiency is by use of adaptive streaming. The system constantly monitors the time between when information is sent from a host user to when it is received by the viewer(s). This information is useful to the host because the host can visually see how much delay there is between what the host is presently viewing on his or her screen and what viewers are being shown. Additionally, this “roundtrip” time monitoring allows the system to automatically increase and decrease framerate and/or compression as needed to maintain an acceptable amount of delay between the two sides of a screen sharing session.

In one example, a system for screen sharing includes: a host device including a host device processor, a host device memory, a host device visual data output device, and a host device communication subsystem, wherein the host device memory includes instructions that when executed by the host device processor cause the host device to perform the ascribed actions; one or more viewer devices, each viewer device including a viewer device processor, a viewer device memory, a viewer device visual data output device, and a viewer device communication subsystem, wherein the viewer device memory includes instructions that when executed by the viewer device processor cause the viewer device to perform the ascribed actions; and one or more central server devices, each central server device including a central server processor and a central server memory, wherein the central server memory includes instructions that when executed by the central server processor cause the central server to perform the ascribed actions; two or more reflection server devices, each reflection server device including a reflection server processor and a reflection server memory, wherein the reflection server memory includes instructions that when executed by the reflection server processor cause the reflection server to perform the ascribed actions; wherein, in response to receiving a request to host a visual data sharing session from the host device to share visual data with the one or more viewer devices, the one or more central servers: selects a one of the two or more reflection servers to serve as a selected reflection server for the visual data sharing session; generates a unique URL for the one or more viewer devices to access the visual data sharing session via the reflection server; in response to one or more of the viewer devices accessing the URL, establishes a communication connection between the host device and the one or more viewer devices; and transmits visual data captured on the host device to the one or more viewer devices.

In one embodiment, the selected reflection server and the central server device may be the same server. In another embodiment, as part of the selection of the selected reflection server selects a one of the two or more reflection servers to serve as a selected reflection server for the screen sharing session, the central server references a provisioning database including information detailing reflection server locations, reflection server capacities, or current reflection server loads. In a further embodiment, as part of the selection of the selected reflection server selects a one of the two or more reflection servers to serve as a selected reflection server for the screen sharing session, the central server references data received related to the host device and one or more viewer devices. For example, the data received related to the host device and one or more viewer devices may include the host device and one or more viewer devices locations.

The connection established between the host device and viewer device may utilize a connection handling module run on the reflection server for each instance of a connection between the host device and one of the one or more viewer devices. The connection established between the host device and viewer device may be optimized using a differential update module run on the reflection server, wherein the differential update module only updates visual data that changes. The connection established between the host device and viewer device may be optimized using a transformation detection module run on the reflection server, wherein the transformation detection module only updates visual data that changes. The connection established between the host device and viewer device may be optimized using an adaptive streaming module run on the reflection server, wherein the adaptive streaming module adjusts an amount of compression applied to the shared visual data. The connection established between the host device and viewer device may be optimized using a message queue optimization module run on the reflection server, wherein the message queue optimization module tracks a queue of messages that remain to be delivered between the host devices and the one or more viewer devices and continually culls and combines messages to optimize performance.

The host device may be a desktop computer, a mobile device, or other computer. The unique URL for a session may be transmitted via SMS, email, or instant message. The unique URL for a session may be posted to a website as a link.

The first viewer device may be connected to the host device at a first time via the unique URL for a session and one or more additional viewer devices accessing the unique URL for the visual data sharing session may be placed into a waiting queue. In such embodiments, the one or more viewer devices placed into the waiting queue may be assigned a unique waiting queue number.

Another embodiment of the present invention may be described as a method of providing on-demand, live, presenter hosted, product or service demonstrations via the internet comprising the steps of: providing a server including memory in communication with a processor, the memory including instructions that when executed by the processor cause the server to present a product or service to a user of a first device through a website provided by the server; prompt the user to request an on-demand, live, presenter hosted, product or service demonstration, the prompt including a request for user contact information; in response to receiving the user contact information from the first device, associate the first device with the request for the on-demand, live, presenter hosted, product or service demonstration and generates a unique session identification associated with the request for the on-demand, live, presenter hosted, product or service demonstration; place the unique session identification in a queue of one or more active unique session identifications; notify one or more presenter devices of the one or more active unique session identifications; and when one or more presenters are available to provide the requested on-demand, live, presenter hosted, product or service demonstration, provide the requested on-demand, live, presenter hosted, product or service demonstration through a screen sharing system facilitated by the website provided by the server; and when none of the one or more presenters are available to provide the requested on-demand, live, presenter hosted, product or service demonstration, providing access to a pre-produced demonstration video to the first device.

The method above may also include a step of requesting scheduling of a live, presenter hosted, product demonstration. If none of the one or more presenters are available to provide the requested on-demand, live, presenter hosted, product or service demonstration, the server provides the first device real-time data regarding the availability of the requested on-demand, live, presenter hosted, product or service demonstration and an approximate wait time.

The method above may yet also include contacting the user through a batch contact process wherein the batch contact rate is dependent on the real-time availability of the on-demand, live, presenter hosted, product or service demonstration.

The screen sharing system described as part of this method may comprise: a host device including a host device processor, a host device memory, a host device visual data output device, and a host device communication subsystem, wherein the host device memory includes instructions that when executed by the host device processor cause the host device to perform the ascribed actions; one or more viewer devices, including the first device, each viewer device including a viewer device processor, a viewer device memory, a viewer device visual data output device, and a viewer device communication subsystem, wherein the viewer device memory includes instructions that when executed by the viewer device processor cause the viewer device to perform the ascribed actions; and one or more central server devices, including the server, each central server device including a central server processor and a central server memory, wherein the central server memory includes instructions that when executed by the central server processor cause the central server to perform the ascribed actions; two or more reflection server devices, each reflection server device including a reflection server processor and a reflection server memory, wherein the reflection server memory includes instructions that when executed by the reflection server processor cause the reflection server to perform the ascribed actions; wherein, in response to receiving a request to host a visual data sharing session from the host device to share visual data with the one or more viewer devices, the one or more central servers: selects a one of the two or more reflection servers to serve as a selected reflection server for the visual data sharing session; generates a unique URL for the one or more viewer devices to access the visual data sharing session via the reflection server; in response to one or more of the viewer devices accessing the URL, establishes a communication connection between the host device and the one or more viewer devices; and transmits visual data captured on the host device to the one or more viewer devices.

The screen sharing system described as part of this method may also comprise a host device including a host device processor, a host device memory, a host device visual data output device, and a host device communication subsystem, wherein the host device memory includes instructions that when executed by the host device processor cause the host device to perform the ascribed actions; one or more viewer devices, including the first device, each viewer device including a viewer device processor, a viewer device memory, a viewer device visual data output device, and a viewer device communication subsystem, wherein the viewer device memory includes instructions that when executed by the viewer device processor cause the viewer device to perform the ascribed actions; and one or more central server devices, including the server, each central server device including a central server processor and a central server memory, wherein the central server memory includes instructions that when executed by the central server processor cause the central server to perform the ascribed actions; two or more reflection server devices, each reflection server device including a reflection server processor and a reflection server memory, wherein the reflection server memory includes instructions that when executed by the reflection server processor cause the reflection server to perform the ascribed actions; wherein, in response to receiving a request to host a visual data sharing session from the host device to share visual data with the one or more viewer devices, the one or more central servers: selects a one of the two or more reflection servers to serve as a selected reflection server for the visual data sharing session; establishes a communication connection between the host device and the one or more viewer devices; and transmits visual data captured on the host device to the one or more viewer devices.

A goal of the present invention is to provide a screen sharing system that is accessible to virtually every device that can browse the internet. Presently, almost every adult in America owns at least a smartphone or tablet. Such devices enable their owners to access the web from almost anywhere and, with the present invention, these device owners can also view a screen sharing session and be presented with information and assistance from anywhere with an internet connection. The present invention makes such access possible by requiring no additional software, beyond a web browser (which installed on most devices by default), to be installed by viewer(s) of a screen sharing session. This means the current system can be used not only on the latest technologies but can also be utilized by older antiqued computers and web browsers. Such support is important in areas of the world where technology has lagged behind due to financial reasons, geopolitical issues, etc.

Along with supporting almost all internet users around the world, the present invention also seeks to improve and streamline the screen sharing process. Current screen sharing software solutions are very awkward to set up and utilize due to use of long security codes, longer URLs to navigate to a hosted sharing session, and antiqued user interface (UI) controls. The present invention provides a sleek and easy to use solution that allows screen sharing hosts to invite viewers with the click of a button. The present invention further provides innovative UI controls and host tools.

Another advantage of the present invention is that it optimizes screen sharing hosting, which typically requires a good deal of bandwidth and processing power. By use of connection handling modules, modules that selectively detect and send piecemeal updates to the screen sharing feed, and modules which adjust the compression and/or frame rate of a screen sharing feed, the present invention substantially reduces the bandwidth and processing power needed for end users and servers to host a screen sharing session.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1A is a schematic diagram of a multiplatform screen sharing system.

FIG. 1B is a flowchart of the differential update module.

FIG. 2 is a schematic diagram of system data flow into a logging and reporting database of the multiplatform screen sharing system.

FIG. 3 is an example screen shot of a web browser with a browser extension of the multiplatform screen sharing system installed.

FIG. 4 is an example screen shot of the multiplatform screen sharing system browser extension initiating a screen sharing session.

FIG. 5 is an example screen shot of the multiplatform screen sharing system browser extension sharing a browser tab.

FIG. 6 is an example screen shot of the multiplatform screen sharing system displayed on a viewer device.

FIG. 7 is a lobby screen of the multiplatform screen sharing system displayed on a viewer device

FIG. 8 is a waiting screen of the multiplatform screen sharing system displayed on a viewer device.

FIG. 9 is an overview schematic of a host user device.

FIG. 10 is a flowchart which illustrates the steps involved in utilizing a multiplatform screen sharing system to demonstrate software to a prospective client.

FIG. 11A is a hosted website of a company utilizing a multiplatform screen sharing system to prompt prospective clients with an offer for a software demonstration upon the client's desktop computer.

FIG. 11B is a hosted website of a company utilizing a multiplatform screen sharing system to display a prompt to prospective clients with an offer for a software demonstration upon the client's mobile device.

FIG. 12A is a website of a company utilizing a multiplatform screen sharing system to display an alternative prompt to prospective clients with an offer for a software demonstration.

FIG. 12B is a hosted website of a company utilizing a multiplatform screen sharing system to display a pop-up prompt to prospective clients with an offer for a software demonstration upon a mobile device.

FIG. 13A is a contact information collection window displayed upon a website generated by a multiplatform screen sharing system.

FIG. 13B is a contact information collection window displayed upon a website generated by a multiplatform screen sharing system upon a mobile device.

FIG. 14A is a contact information collection window displayed upon a website collecting optional contact information.

FIG. 14B is a contact information collection window displayed upon a website collecting optional contact information on a mobile device.

FIG. 15A is a contact information collection window displaying a status indicator.

FIG. 15B is a contact information collection window displaying a status indicator on a mobile device.

FIG. 16A is a scheduling window displayed in response to no available sales staff being logged in to conduct a screen sharing session.

FIG. 16B is a scheduling window displayed in response to no available sales staff being available to conduct a screen sharing session on a mobile device.

FIG. 17A is a video demonstration window displayed in response to no sales staff being available to conduct a screen sharing session.

FIG. 17B is a video demonstration window displayed in response to no available sales staff being available to conduct a screen sharing session on a mobile device.

FIG. 18A is a contact information collection window after a sales agent has selected a potential client's session identifier from the waiting queue.

FIG. 18B is a contact information collection window displayed on a mobile device after a sales agent has selected a potential client's session identifier from the waiting queue.

FIG. 19A is a contact information collection window after a sales agent has started a demonstration call with a potential client.

FIG. 19B is a contact information collection window displaying a status indicator after a sales agent has started a demonstration call with a potential client.

FIG. 20A is a viewing device displaying a screen sharing session.

FIG. 20B is a viewing device displaying a screen sharing session on a mobile device.

FIG. 21 is a screen of a web browser with a browser extension of the multiplatform screen sharing system installed.

FIG. 22 is a screen of a GUI of a host device when the waiting queue for screen sharing sessions is empty.

FIG. 23 is a screen of a GUI of a host device when the waiting queue is populated.

FIG. 24 is a screen of a GUI of a host device preparing to provide a live software demonstration.

FIG. 25 is a screen of a GUI displaying real time updated contact details of a viewing device user.

FIG. 26 is a screen of the GUI of a host device conducting a screen sharing session.

### DETAILED DESCRIPTION OF THE INVENTION

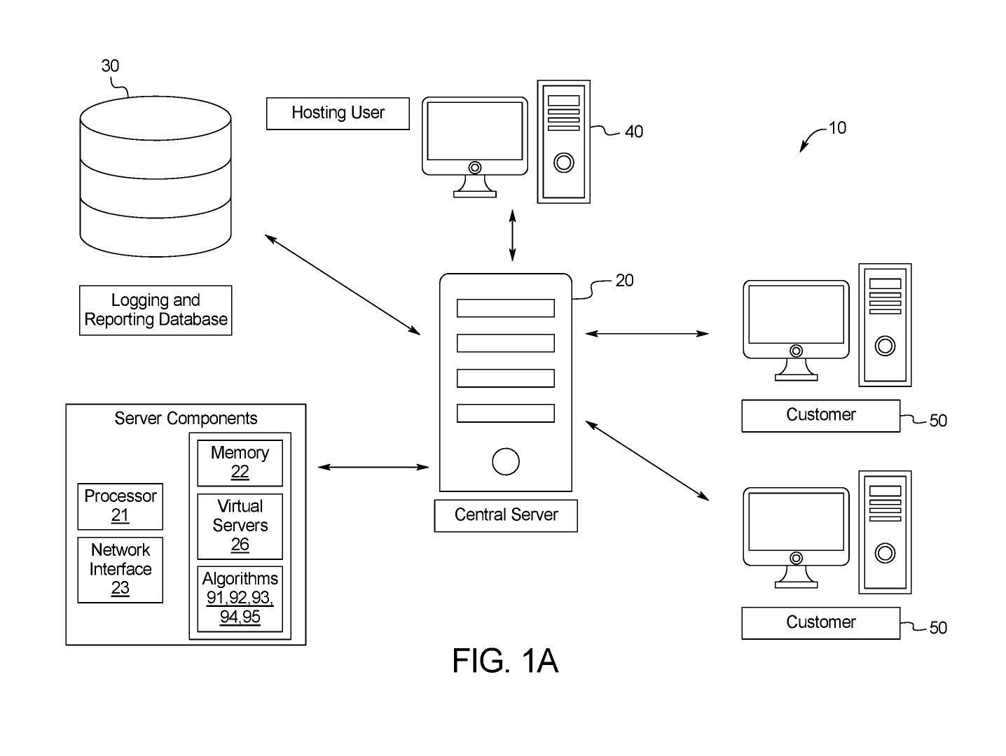

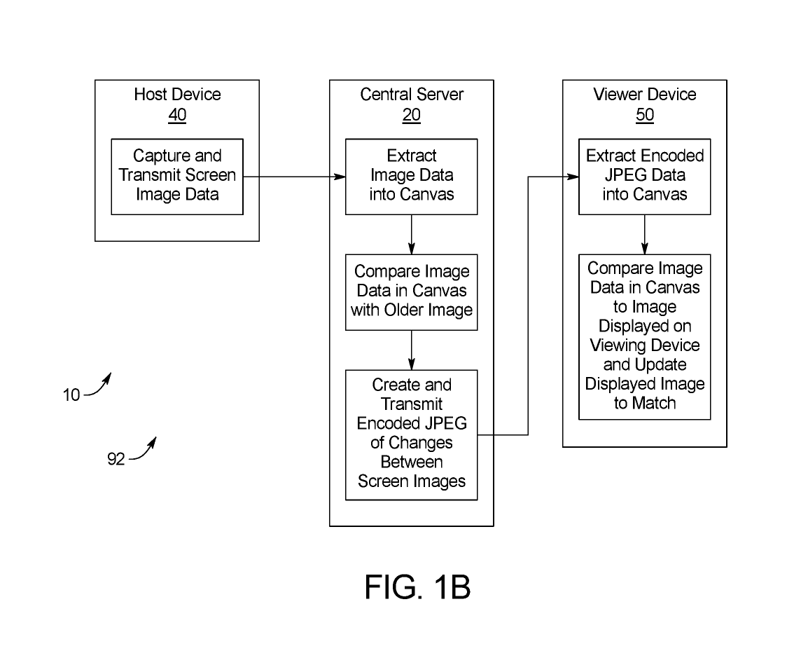

FIG. 1A is an overview schematic diagram of an example of a multiplatform screen sharing system 10. In the example shown in FIG. 1A, the system 10 includes a centralized server 20, a logging and reporting database 30, a host user device 40, and viewer device(s) 50. The centralized server 20 contains a processor 21, memory 22, and network interface 23. The server's 20 memory 22 may store modules and other pieces of code related to hosting screen sharing sessions. One such module may, in essence, split a single physical server 20 in two or more virtual servers 26, with these virtual servers 26 being capable of carrying out different tasks simultaneously and independent from one another. In this embodiment, the virtual servers 26 included within the centralized server 20 include a reflection server 27 and a provisional sever 28. It is important to note that, while in this embodiment one physical server 20 houses a virtual reflection server 27 and provisional sever 28, such tasks could be carried out over multiple physical servers 20 in addition to/or instead of the virtual servers 26. Additionally, it is foreseeable that eventually a centralized server 20 may no longer be required, with some or all of the functionality of the centralized server 20 described herein carried out by other system 10 components.

The provisional server 28, in this embodiment, acts as a traditional database server and stores information regarding users and reflection servers 27. Specifically, information concerning the geographical location of users and the reflection severs 27 are stored by the provisional server 28 and used by the system 10 to deduce which reflection server 27 should be used to host a given screen sharing session 100. This is valuable because the proximity of users geographically to a reflection server 27 can greatly impact the quality (e.g., lower latency, higher bandwidth, etc.) of a screen sharing session 100.

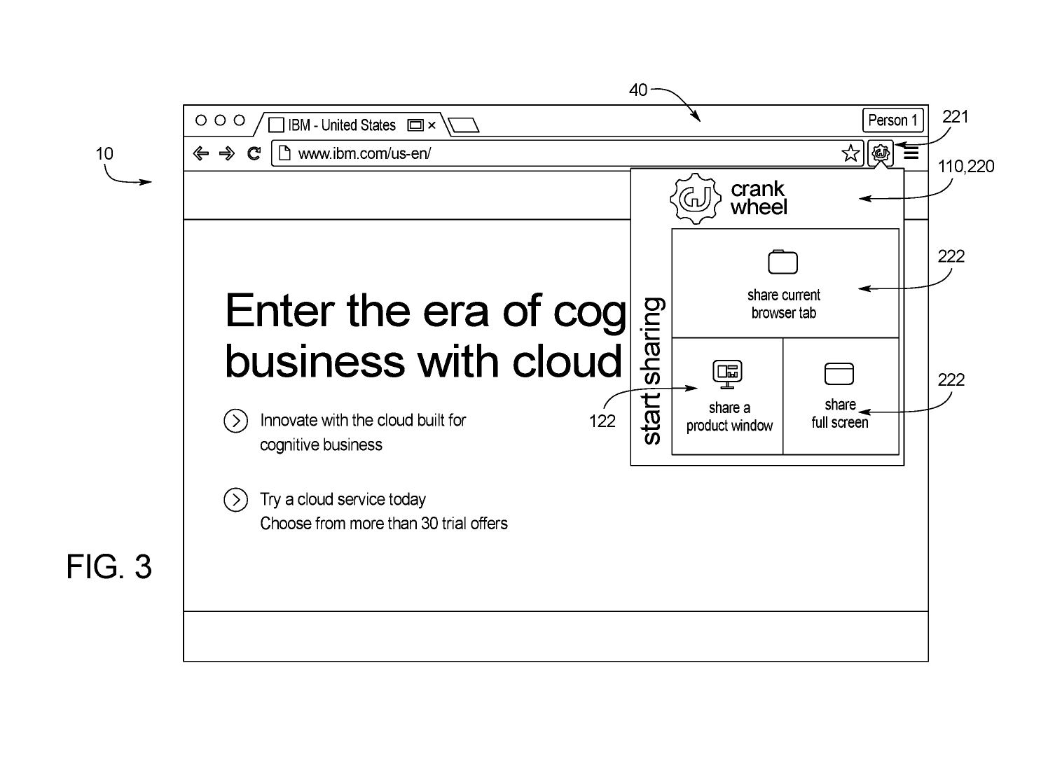

The reflection server 27 is tasked primarily with establishing, authenticating, and maintaining connections between host user devices 40 and viewer devices 50. The reflection server 27 (in virtual or physical form) may be programed using Erlang (or another programming language capable of programming servers) and runs a connection handling module 91. The connection handler module 91 may be programed in a programming language capable of handling automate connection management and, when initiated by a host user device 40 (by initiating a screen sharing session 100; shown in FIGS. 3-5), first authenticates the connection via Auth0 (or another authentication service). After authentication, the connection is ready and the host user, via the host user device 40, may transmit a URL for the screen sharing session 100 to viewing device(s) 50. A unique identifier for the session 100 (e.g., a key or hash generated based upon the host user's email address) is stored in the portion of the memory 22 of the server 20 dedicated to the reflection server 27.

When the viewing device(s) 50 utilize the URL link sent to them, a separate instance of the connection handler module 91 is initiated for the given viewing device 50. The connection handler module 91 authenticates the viewer's connection and then queries the memory 22 of the server 20 dedicated to the reflection server 27. The module 91 finds the unique identifier for the host user device's 40 screen sharing session 100 and establishes a connection between the two devices 40, 50. After this, whenever information is sent from the host device 40, the connection handler 91 for the host device 40 forwards the information on to the connection handler 91 for the viewer device 50 and vice versa.

Once a screen sharing session 100 is established, the system 10 may utilize various other modules to stabilize and maintain the session 100. One such module (which can also be a combination of several smaller pieces of code, modules, etc.) maximizes the use of bandwidth by use of differential updates. The differential update module 92 works, in a preferred embodiment, by monitoring the frequently captured images of what the host user device 40 wants to share (e.g., a browser tab, full screen or a particular window). The module 92 then calculates a differential update of which portions of the transmitted images need to be updated on the viewer's end, based off any changes made on the host device 40 screen so that the viewer device 50 will display an equivalent image. Effectively, the differential update module 92 tracks what the latest image transmitted to the viewer device 50 was and only sends updates to that image instead of an entirely new image.

A detailed description of this embodiment of the differential update module 92 is shown in FIG. 1B and is as follows: at a first step, on the originating side (e.g., the host user device 40) the system 10 captures a snapshot of the shared tab (or whole screen, program window, etc.) periodically from the HTML5 media stream (e.g., the video stream generated by the host user device 40). At a second step, the snapshot is put into a canvas with all pixels of the snapshot extracted as image data. At a third step, the module 92 compares the extracted image data concerning the pixels present in the new screen shot with a previous snapshot taken earlier in time and conveys each change detected into a new canvas. At a fourth step, the information conveyed to a new canvas concerning changes between snapshots is transformed into a jpeg encoded version and this jpeg encoded version of the data, including information concerning the coordinates of where the changes took place, is then transmitted to the remote side (e.g., the viewer device 50).

At a fifth step, once the transmitted data reaches the viewer device 50, the differential update module 92 takes the encoded jpeg data and corresponding coordinates concerning changes made on the host devices 40 screen and places them into a canvas. At a sixth step, the module 92 compares the data placed on the viewer side canvas with the snapshot currently being displayed on the viewer device 50, detects any changes between the snapshot and changed image data on the canvas, and updates the snapshot displayed on the viewer device 50 accordingly.

The differential update module 92 may also monitor the amount of bandwidth and processing power required to perform the series of steps mentioned above and automatically opt to send full frame updates as opposed to piecemeal ones if doing so would be more efficient. The module 92 may also utilize Web Real-Time Communication (WebRTC), if available. If full frame updates are sent, visual movement of the cursor on the host device 40 may be difficult to track for the viewer of the shared screen and the system 10 may address such difficulty by tracking cursor movement and storing the previous positions of the cursor on the shared screen. The system 10 will then create a “mouse trail” which represents the movement of the cursor. The mouse trail may consist of a full opaque visual element (e.g., a traditional cursor or colored dot) with successively older cursor positions represented by successively more transparent visual elements. The number of older cursor positions displayed may be capped (e.g., 2-4) to prevent the mouse trail from becoming a distraction.

Another module the system may utilize to help increase the efficiency of screen sharing hosting is a transformation detection module 93. This module 93 works by detecting when a host device 40 scrolls down the page when sharing their screen (or scrolls up, to the side, drags and drops a window, rotates an image, etc.) and works to manipulate image data already sent to a viewer device 50 instead of sending a full frame update. The transformation detection module 93 works somewhat similarly to the differential update module 92 in that both compare the image data between the newest screen capture generated by the host device 40 and the screen capture last sent to the viewer device 50 to detect what has changed between the two images. The transformation detection module 93 compares the images pixel by pixel and determines the amount of transformation that has taken place (e.g., how far did the host scroll down the shared web page). If this comparison reveals that the changes between the two screen capture images was sufficiently purely transformative (e.g., the web page was scrolled down one paragraph with no other changes made), the transformation detection module 93 will move the image data which is the same between the older screen capture and new one according to the location changes (i.e., transformation data) detected and fill in the rest of the image with the new image data not previously transmitted to the viewer device 50. In this way, only partial screen captures need to be sent when a host device 40 scrolls down a shared web browser tab, etc. potentially saving bandwidth when compared to sending full screen capture updates.

Yet another module the system 10 may use to maximize screen sharing hosting efficiency is an adaptive streaming module 94. The adaptive streaming module 94 works to adjust the amount of compression and/or frame rate sent from a host user device 40 to a viewer device 50. This module 94 functions by tracking the “round trip” time a screen capture takes to be transmitted from the host user device 40 to the viewer device 50. Based on the lag time between when a screen capture is generated and when it is received, the adaptive streaming module 94 may, in small increments, increase or decrease compression and/or the frame rate of the shared screen video feed sent to the viewer device 50. For instance, if the round trip time is well within the acceptable limits set by the module 94, the compression of the video feed being generated by the system 10 may be lowered. This would provide a higher quality video feed to the viewer device and, if decreasing such compression keeps the round trip time of updated screen captures being sent to the viewer device 50 within acceptable limits, maximizes the efficiency of the screens sharing session (e.g., highest quality possible while keeping lag to a minimum). The adaptive streaming module 94 may also automatically detect acceptable round trip times at the start of a screen sharing session by sending test messages between the host device 40 and viewer device 50 to detect the anticipated turnaround time for a given session. This is important because the lag time from session to session can vary a great deal due to geographical location of host and viewer, current server load, etc.

Working closely with the adaptive streaming module 94, a message queue optimization module 95 also works adaptively to help boost screen sharing server 20 performance. This module 95 works by keeping track of the queue of messages (e.g., screen capture images, etc.) that remain to be delivered between users (e.g., host user devices 40 and viewer devices 50) and continually culling and combining messages when possible. Such actions are achieved, in one example, by the module 95 examining the message queue before transmitting any messages to determine if there is a full frame update (e.g., full screen capture of the shared tab, window, etc.) in the queue. If there is, any differential updates that are older than the full frame update are discarded by the module 95.

The message queue optimization module 95 can also deduce heuristics changes based off performance of the message queue. For instance, if the queue is very long, this is a sign that system 10 users are not receiving messages fast enough. The module 95 can instruct the system 10 to recompress images in the queue at a higher compression ratio while also instructing the host user device 50 to boost compression and/or drop framerate as well. This monitoring of the message queue enables the system 10 to respond faster to performance drops than it otherwise would, since the alternative would be to wait for the adaptive streaming module 94 to make adjustments based off round trip message time (round trip time calculation requires delivery of messages, if the messages were stuck in the message queue undelivered, the adaptive streaming module 94 would be slower to respond to such issues).

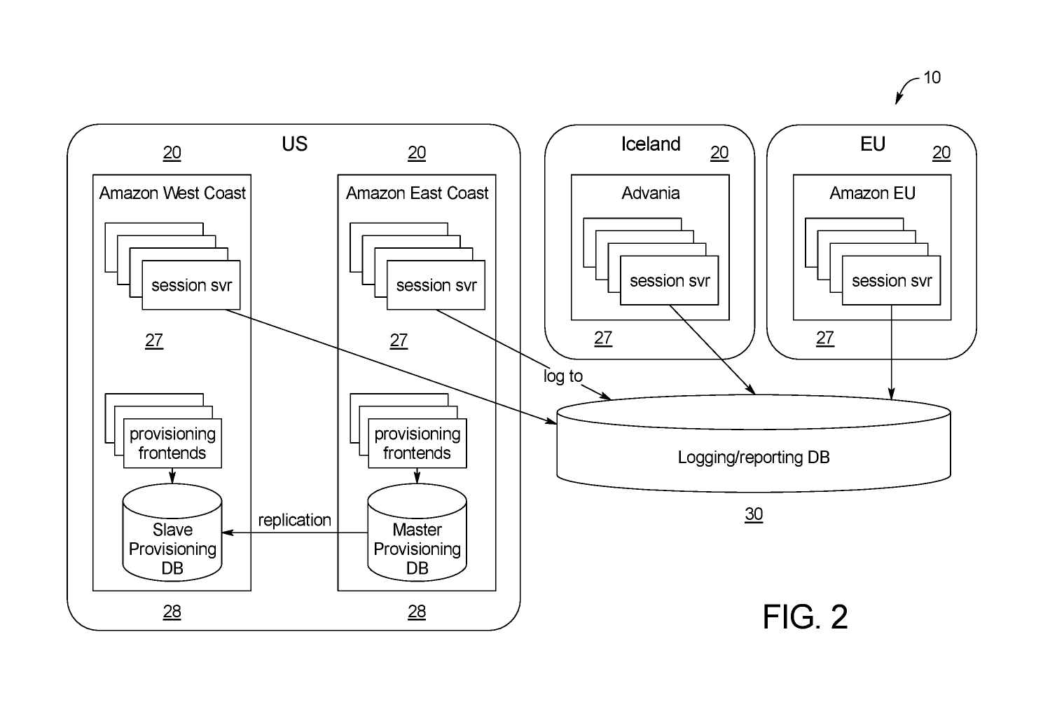

FIG. 2 is an overview diagram of system 10 data flow into the logging and reporting database 30 of the multiplatform screen sharing system 10. As shown in FIG. 2 (and mentioned in FIG. 1A) the system 10 may utilize more than one physical server 20 and/or virtual server 26. In this embodiment, the USA has a west coast server and east coast server. Each of these servers is further separated physically or virtually into provisional servers 28 and reflection servers 27. Further shown in FIG. 2, the provisional servers 28 may be replicated across multiple locations, in this case the east and west coast severs in the USA. In this embodiment, Iceland and the EU also have a reflection server 27 present and data from all of these servers is feed into a centralized logging and reporting database 30. This centralized database 30 is useful for generating billing based off customer service rendered via screen sharing and is also good for audit logging. The logging and reporting database 30 may record session details from the reflection servers including who hosted a screen sharing session (e.g., which customer service rep), the length of a session, the viewer(s) of the session, and details entered manually by the host user about the session. In some embodiments of the system 10, the logging and reporting database may also store recorded screen sharing sessions and automatically generate reports based off the content of the session. The system 10 may generate reports detailing important links shared during a session, step-by-step “how to” guide screen captures from a session, and other useful information automatically based off each screen sharing session by use of optical character recognition (OCR) and other content recognition tools. Such content recognition tools may also be used to block out certain content that should not be shared with viewer devices 50 (e.g., credit card numbers, internal links, etc.).

FIG. 3 is a screen of a web browser with a browser extension 110 of the multiplatform screen sharing system 10 installed. As shown in FIG. 3, a host user device 40 may install a browser add-on extension 110 (in this case a Google Chrome extension) that installs a graphical user interface 220 (GUI) that enables users to host screen sharing sessions on the system 10. Users of a host device 40 may be required to create a log-in for the system 10, with the details about each user being recorded in the provisioning sever 28 and logging database 30 (as discussed in FIGS. 1-2). Once a host user is logged in, he or she may click a shortcut icon 221 which opens up the system 10 GUI 220. In this embodiment, the GUI 220 features command buttons 222 capable of initiating a screen sharing session 100. The buttons 222 allow a host user device 40 to share the current tab being viewed within a web browser, a program window, or the full screen of the host user device 40.

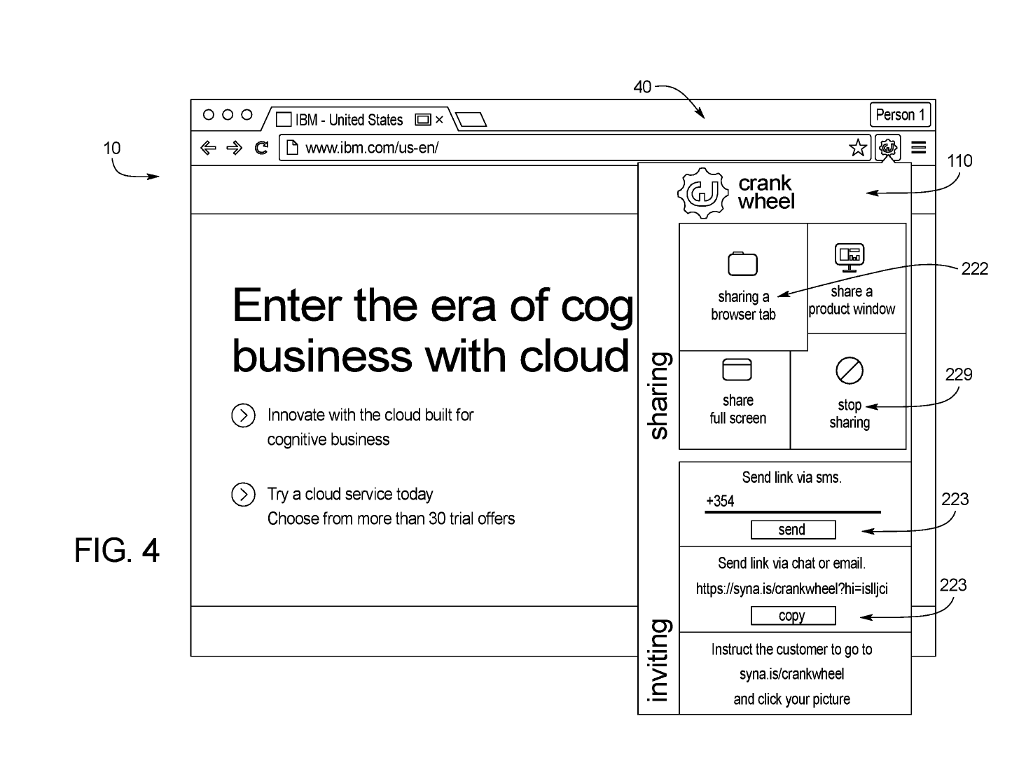

FIG. 4 is a screen of the multiplatform screen sharing system 10 browser extension 110 initiating a screen sharing session 100. As shown in FIG. 4, when a user of a host device 40 elects to share his or her screen (in this case sharing the current browser tab and not the whole screen) by clicking the corresponding command button 222, the system 10 initiates the screen sharing session 100 automatically and provides URL session links 223 that may be shared with viewer devices 50 via SMS, email, instant message, etc. The links 223 generated by the system 10 are private in nature with each new session getting a new, randomly generated, cryptographically secure link 223. This insures viewer devices 50 who had a private link 223 to previous sessions 100 cannot get into the new sharing session 100.

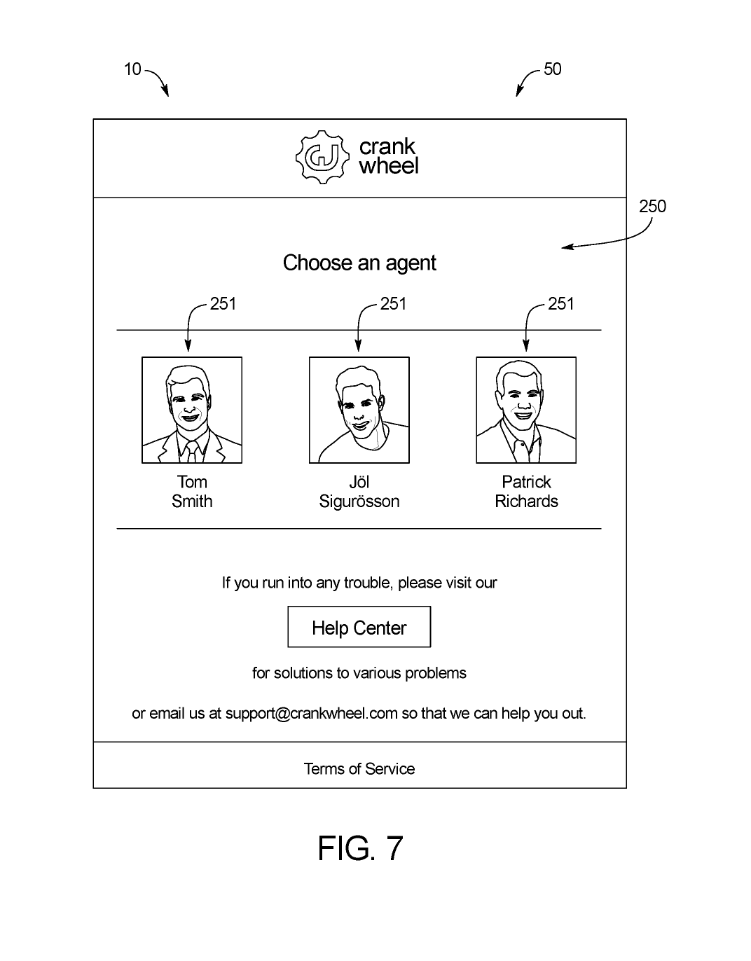

When a user of a host device 50 initiates a screen sharing session 100, a link to the session 100 may also be posted to a directory website (e.g., the customer service page of a company) for ease of access. This directory website may also be made up to resemble a “lobby” (pictured in FIG. 7) with multiple session links posted in the same spot. Also worth noting is the stop sharing command button 229 which will stop a screen sharing session 100 at any time.

When a screen sharing session is initiated by a host user device 40, the system 10 carries out the tasks mentioned in the discussion of FIG. 1A including authenticating the connection and recording a unique session ID which the system 10 can later use to connect viewer device(s) 50 to the host user device's 40 screen sharing session 100.

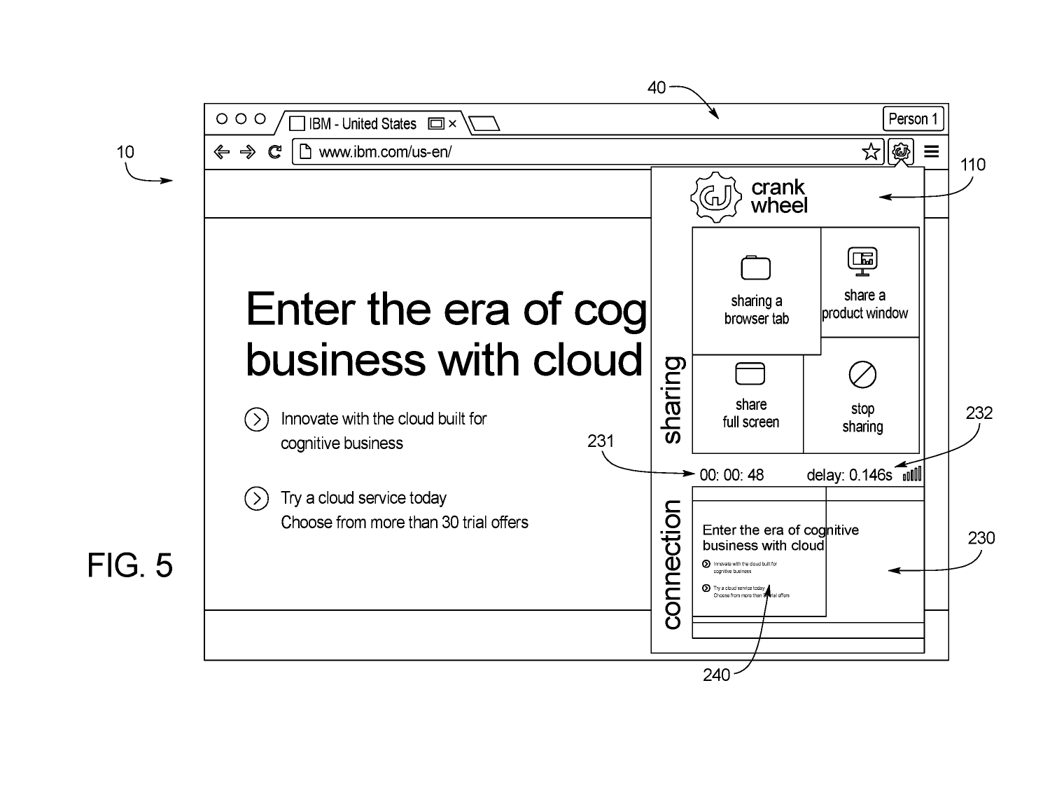

FIG. 5 is a screen of the multiplatform screen sharing system 10 browser extension 110 sharing a browser tab. As shown in FIG. 5, once a screen sharing session 100 is initiated, a preview panel 230 is generated which reflects what the viewer device 50 currently displays on their end. Additionally, a session timer 231 and delay (aka round trip time) tracker 232 are displayed for the user of the host device 40. The preview panel 230 shows the size and location of the customer's viewport 240 (i.e., which part of the video/image stream being sent to the viewer device 50 the viewer is currently seeing in their browser window, on the screen of their mobile device, etc.). If the viewer zooms in or out, or scrolls their viewport 240 around, these updates are reflected in the preview panel 230.

Since the preview panel 230 is important, but not as important as the data sent from host to viewer, the preview panel 230 is generated as follows to minimize hosting burden: whenever the host user device 40 sends an update (full frame or differential update) to the client, the system 10 generates a thumbnail (small, highly compressed) version of the full frame that the viewer device 50 will display once the update is applied. The updated thumbnail is timestamped and/or given a sequence number. Cursor movement updates are also timestamped and/or given a sequence number. The thumbnails and historical cursor updates may be stored locally in the memory of the host device 40 and whenever the viewer device 50 displays the updated thumbnail or cursor movements, the timestamp and/or the sequence number of the displayed updated thumbnail or cursor movement is transmitted back to the host device 40. When the host device receives the timestamp and/or the sequence number, the host device 40 displays the corresponding thumbnail or cursor movement stored for that timestamp and/or sequence number in the preview panel 230. At this point, any thumbnails older than the one displayed are deleted and stored thumbnails are regularly culled to prevent a backup which might slow system 10 performance. While the above is a preferred method of generating the preview panel 230, the system 10 may also generate the panel 230 by sending full frame screenshots from the viewer device 50 back to the host device 40 if preferable in a given situation.

Information regarding the viewing devices 50 viewport 240 may be captured by HTML5 DOM APIs to retrieve information about the upper left corner (in document coordinates) of the viewport 240, and the height and width of the viewport in logical pixels. The logical pixel size of the images displayed by the system 10 on the viewer device 50 are known and this information is used to transmit back to the host device 40 information regarding the relative size of the upper left and bottom right corners of the image on the viewer device 50. From this the system 10 can discern the size and shape of the viewer device's 50 current viewport 240. Additionally, using HTML5 visibility API, the system 10 can detect if the viewport 240 has become totally obscured on the viewer device 50 and display an alert in the preview panel which states as much. For example, if the viewer device 50 was a mobile device and the user of this device 50 pressed the home button on their device 50 to check Facebook, the host device 40 would display a notification which states “Viewer's Window is Hidden” or a message with similar content.

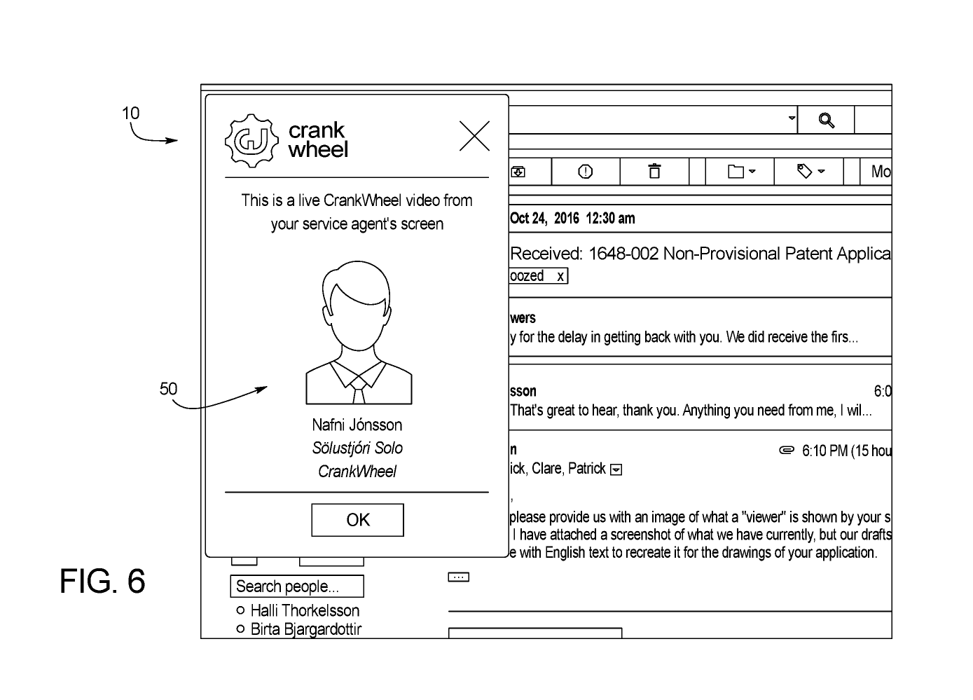

FIG. 6 is a screen of the multiplatform screen sharing system 10 displayed on a viewer device 50. As shown in FIG. 6, the view device 50 requires no additional software beyond a web browser to access the multiplatform screen sharing system 10. When the viewer device 50 accesses a link (discussed in FIG. 4) to join a screen sharing session 100 the system 10 again authenticates the connection, looks up the unique ID assigned to the session, and connects the host user device 40 and viewer device 50. This all occurs automatically and on the frontend, the viewer device 50 displays a welcome message from the system 10, informing the users of the device 50 that they are connected to a screen sharing session 100.

FIG. 7 is a lobby 250 screen of the multiplatform screen sharing system 10 displayed on a viewer device 50. As shown in FIG. 7, the lobby screen 250 may be a website which has clickable visual elements 251 (e.g., a clickable pictures of customer service agents) which act as URL session links 223 and navigate a viewer device 50 to a respective screen sharing session 100. For instance, if the user of a viewer device 50 calls into customer service, they may be directed to the given company's customer service page. Here, a lobby screen 250 may be displayed which allows the user seeking customer service to click on the name of face of the customer service agent to whom he or she is speaking to on the phone (or over chat, email, etc.).

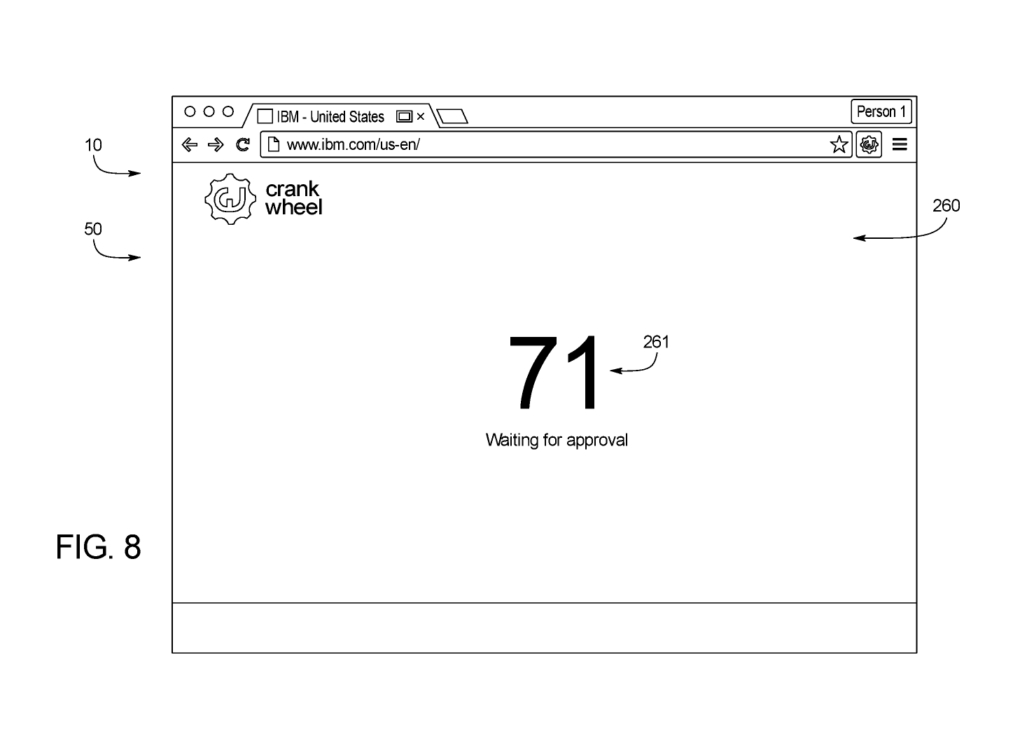

FIG. 8 is a waiting 260 screen of the multiplatform screen sharing system 10 displayed on a viewer device 50. As shown in FIG. 8, the system 10 may utilize a “waiting room” for viewer devices waiting to view a URL session link 223. In a preferred embodiment, the system 10 allows one host device 40 and one viewer device 50 to be connected at one time. For many customer service and sales applications, the number of viewer devices 50 (e.g., the number of customer waiting for customer service) requires many devices 50 and their respective users to be put “on hold” until they can be helped. To manage such needs, the present system 10 may allow multiple host devices 50 and their corresponding instance of the connection handling module 91 to sit in a waiting queue 260. The waiting queue 260 may be stored on the central server 260 and record a unique waiting room number 261 which corresponds to the unique instance of the connection handling module 91 for a given viewer device 50. This number 261 may be displayed on the viewer device 50 and when the host is ready, they may input a waiting room number 261 (as provided to them by a potential viewer) on the host device 40 and the system 10 will connect the corresponding viewer device 50.

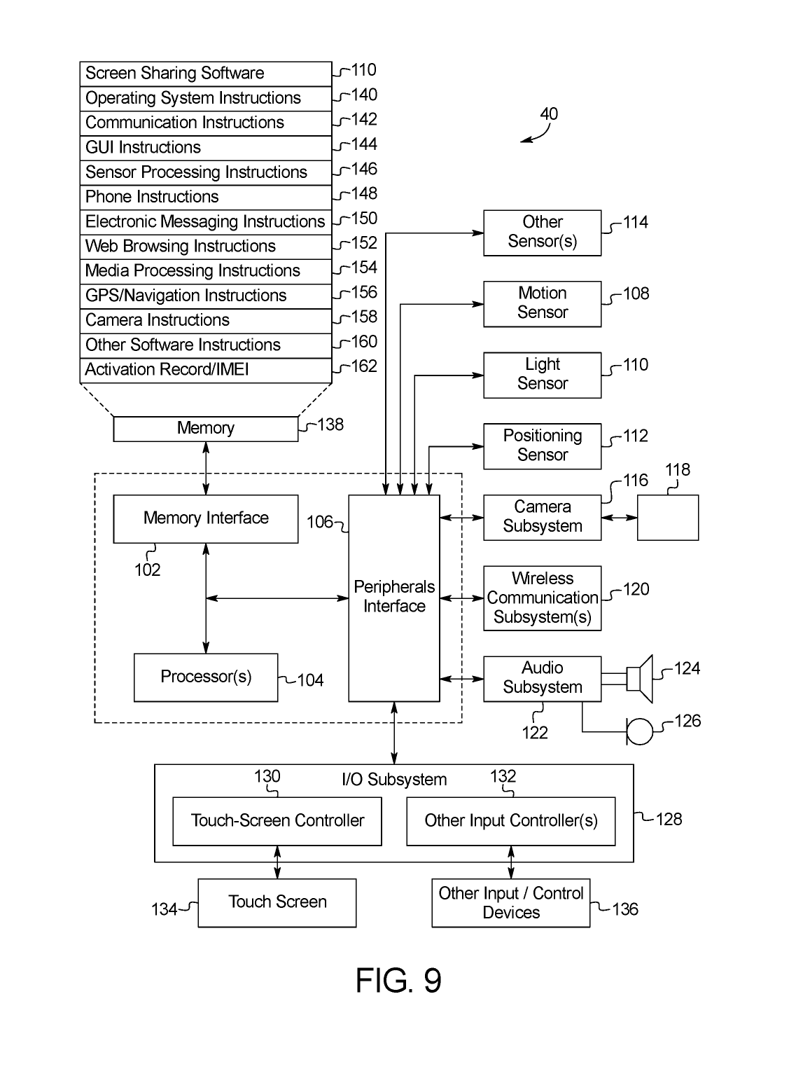

FIG. 9 is an overview schematic of a host user device 40. Similar components and functionalities pictured in this schematic may also be seen in centralized servers 20 and viewer devices 50 of the system 10. As shown in FIG. 9, the host user device 40 may include a memory interface 102, controllers 103, such as one or more data processors, image processors and/or central processors, and a peripherals interface 106. The memory interface 102, the one or more controllers 103 and/or the peripherals interface 106 can be separate components or can be integrated in one or more integrated circuits. The various components in the user device 20 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 163, and positioning sensors 112 (e.g., GPS receiver, accelerometer) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and a physical camera 118 (e.g., a charged coupled device (CCD) or a complementary metal-oxide semiconductor (CMOS) optical sensor) can be utilized to facilitate camera functions, such as recording photographs and video clips. Modern smartphones and other devices typically feature more than one camera 118 operated by the camera subsystem 116.

Communication functions can be facilitated through a network interface, such as one or more wireless communication subsystems 120, which can include radio frequency receivers and transmitters and/or optical (e.g., infrared) receivers and transmitters. The specific design and implementation of the communication subsystem 120 can depend on the communication network(s) over which the user device 20 is intended to operate. For example, the user device 20 can include communication subsystems 120 designed to operate over a GSM network, a GPRS network, an EDGE network, a Wi-Fi or Imax network, and a Bluetooth network. In particular, the wireless communication subsystems 120 may include hosting protocols such that the user device 20 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 may include a touch screen controller 130 and/or other input controller(s) 132. The touch-screen controller 130 can be coupled to a touch screen 134, such as a touch screen. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 may be coupled to memory 44. The memory 44 can include high-speed random access memory and/or non-volatile memory, such as one or more magnetic disk storage devices, one or more optical storage devices, and/or flash memory (e.g., NAND, NOR). The memory 44 may store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 44 may also store communication instructions 142 to facilitate communicating with one or more additional devices, one or more computers and/or one or more servers. The memory 44 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 44 may also store other software instructions controlling other processes and functions of the user device 20 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 44.

Each of the above identified instructions and applications can correspond to a set of instructions for performing one or more functions described herein. These instructions need not be implemented as separate software programs, procedures, or modules. The memory 44 can include additional instructions or fewer instructions. Furthermore, various functions of the user device 20 may be implemented in hardware and/or in software, including in one or more signal processing and/or application specific integrated circuits. Accordingly, the user device 20, as shown in FIG. 2, may be adapted to perform any combination of the functionality described herein.

Aspects of the systems and methods described herein are controlled by one or more controllers 103. The one or more controllers 103 may be adapted run a variety of application programs, access and store data, including accessing and storing data in associated databases, and enable one or more interactions via the user device 20. Typically, the one or more controllers 103 are implemented by one or more programmable data processing devices. The hardware elements, operating systems, and programming languages of such devices are conventional in nature, and it is presumed that those skilled in the art are adequately familiar therewith.

For example, the one or more controllers 103 may be a PC based implementation of a central control processing system utilizing a central processing unit (CPU), memories and an interconnect bus. The CPU may contain a single microprocessor, or it may contain a plurality of microcontrollers 103 for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory is non-transitory and stores at least portions of instructions for execution by the CPU and data for processing in accord with the executed instructions.

The one or more controllers 103 may further include appropriate input/output ports for interconnection with one or more output displays (e.g., monitors, printers, touchscreen 134, motion-sensing input device 108, etc.) and one or more input mechanisms (e.g., keyboard, mouse, voice, touch, bioelectric devices, magnetic reader, RFID reader, barcode reader, touchscreen 134, motion-sensing input device 108, etc.) serving as one or more user interfaces for the processor. For example, the one or more controllers 103 may include a graphics subsystem to drive the output display. The links of the peripherals to the system may be wired connections or use wireless communications.

Although summarized above as standard mobile device implementation, like a smartphone or tablet computer, those skilled in the art will recognize that the one or more controllers 103 also encompasses systems such as host computers, servers, workstations, network terminals, and the like. Further one or more controllers 103 may be embodied in a laptop or desktop computer. In fact, the use of the term controller 103 is intended to represent a broad category of components that are well known in the art.

Hence aspects of the systems and methods provided herein encompass hardware and software for controlling the relevant functions. Software may take the form of code or executable instructions for causing a processor or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

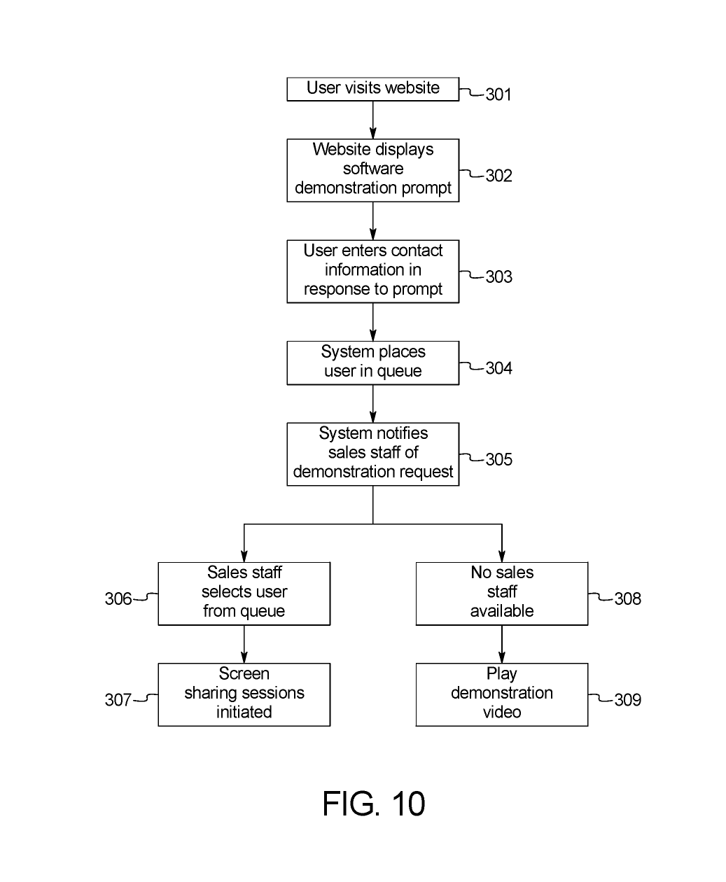

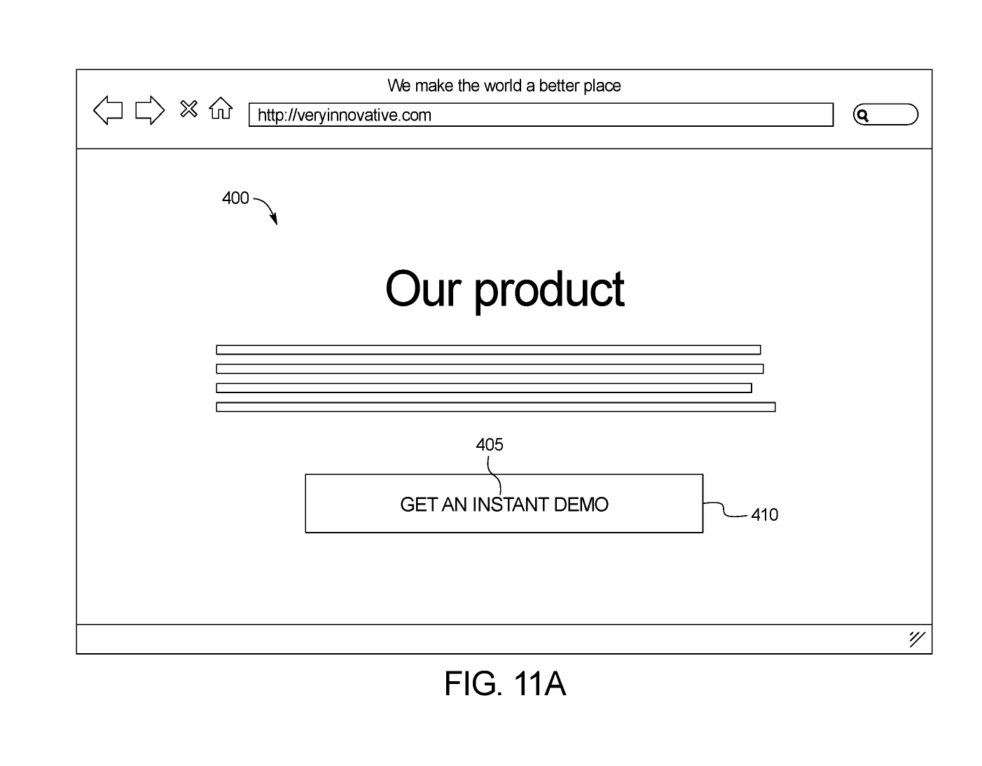

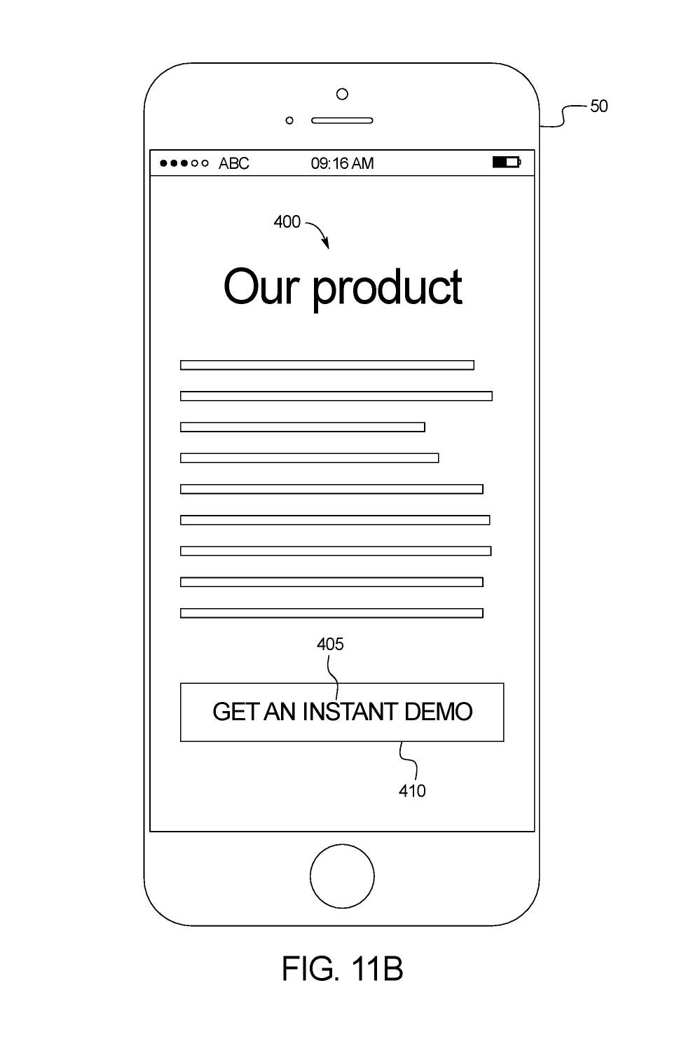

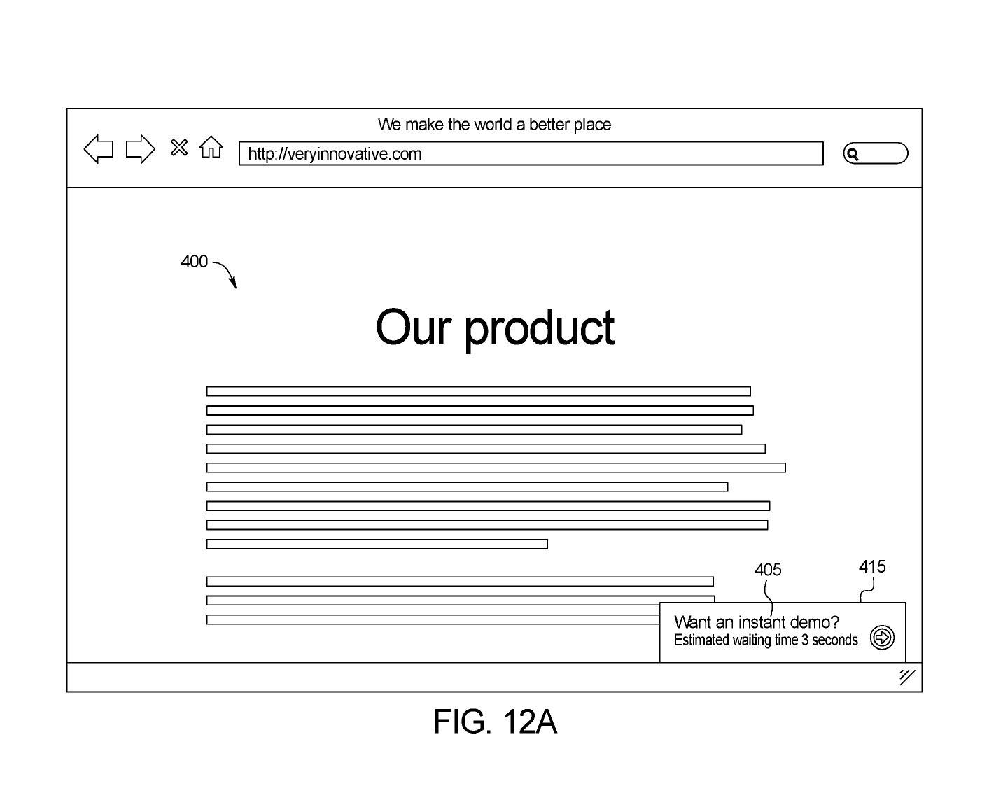

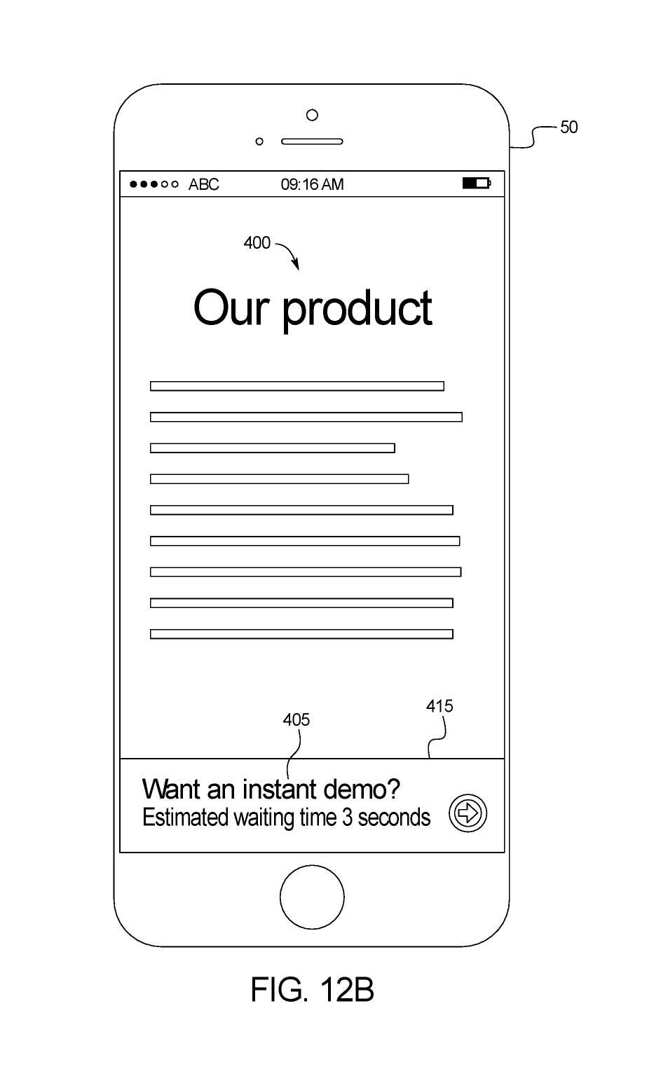

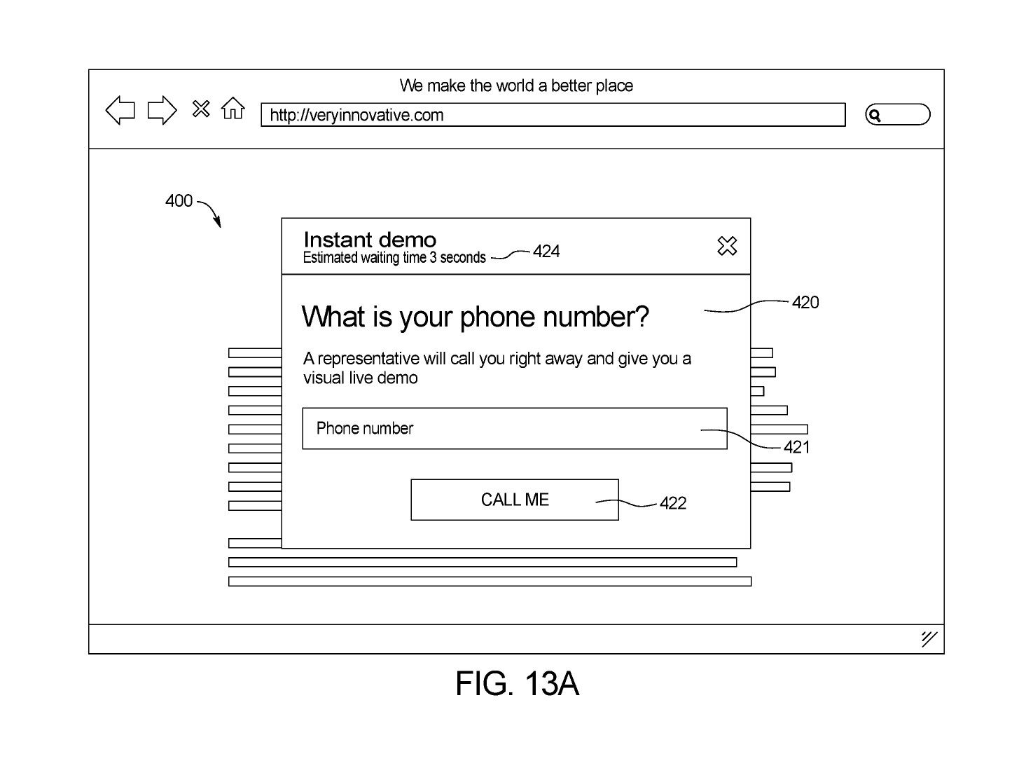

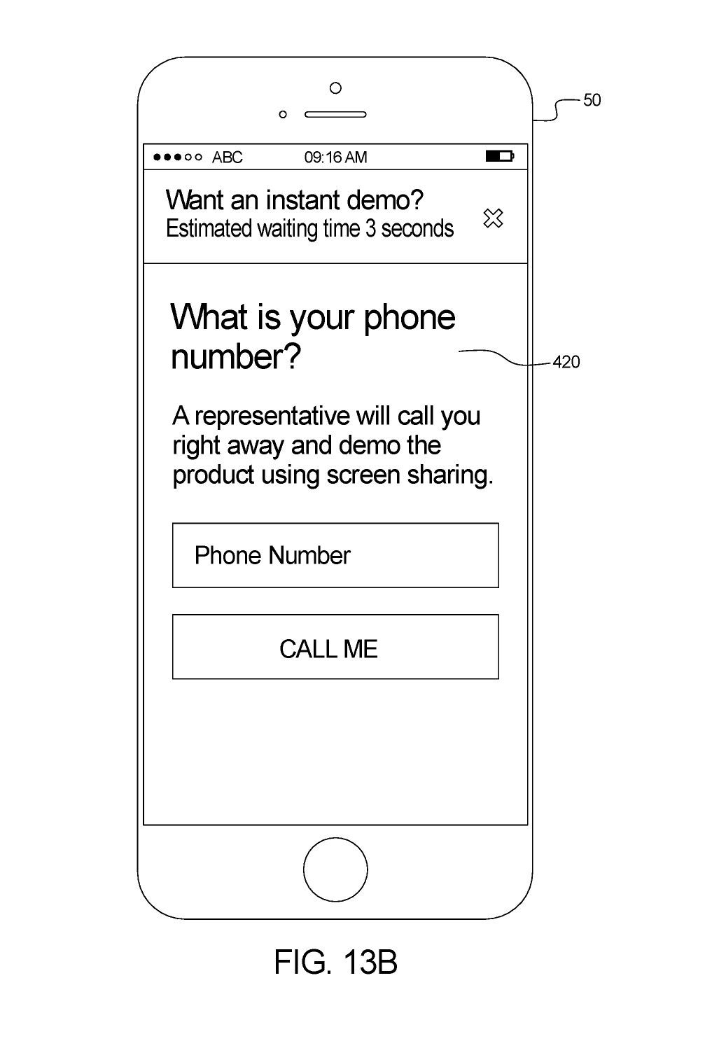

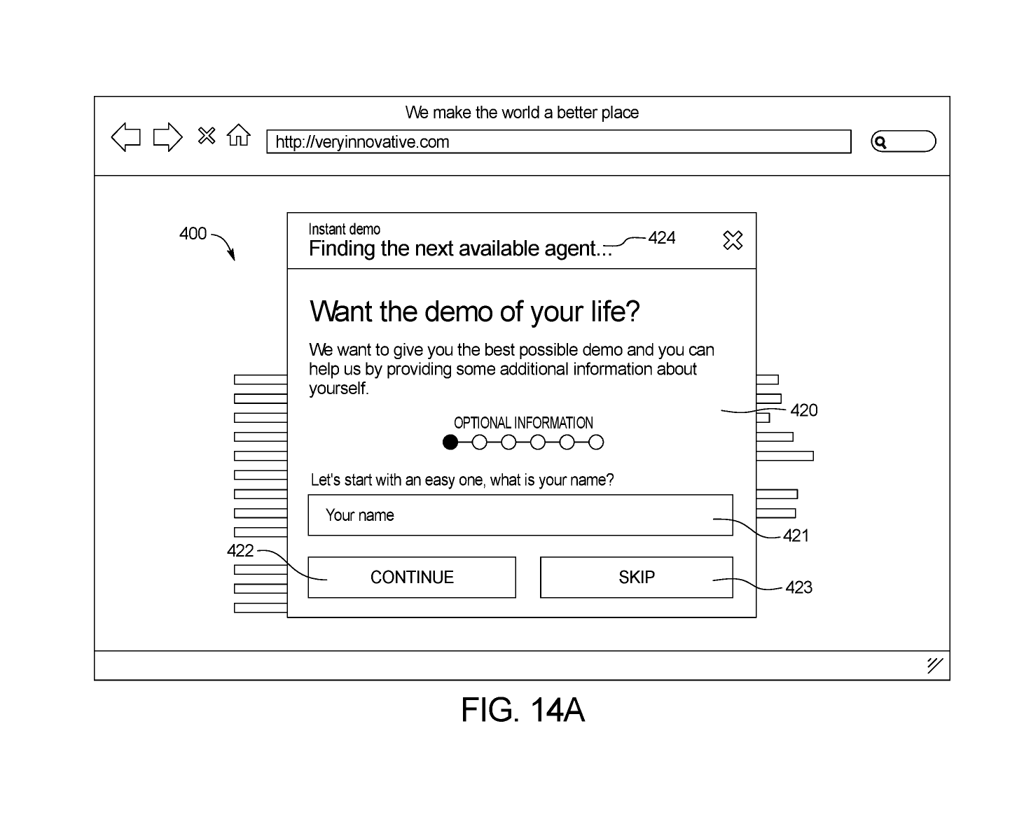

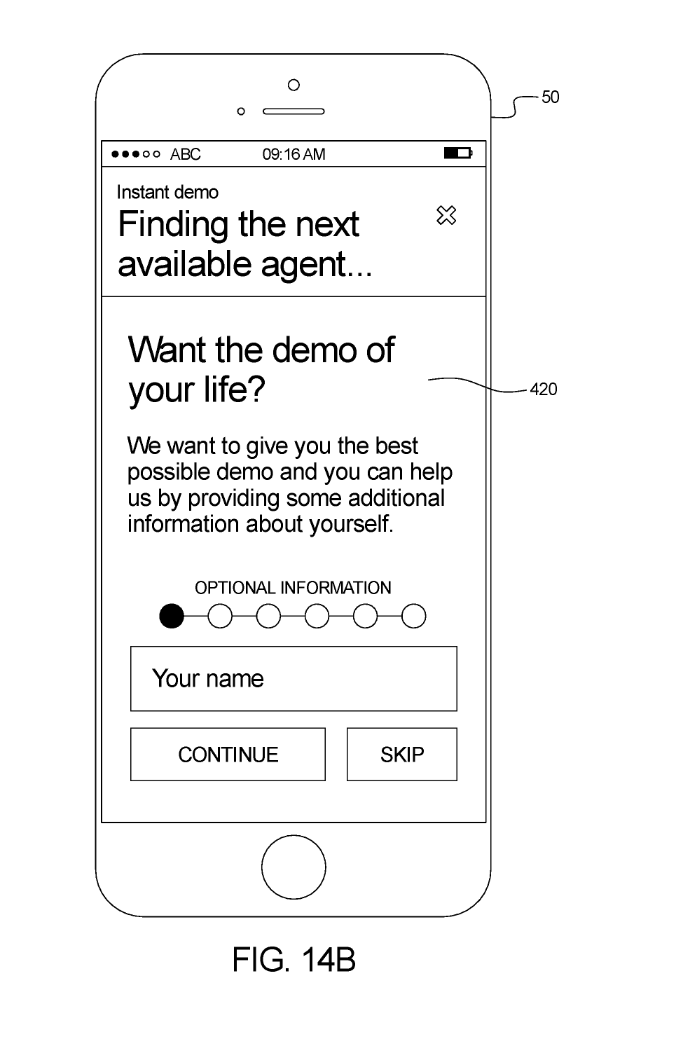

FIG. 10 is a flowchart which illustrates the steps involved in utilizing a multiplatform screen sharing system 10 to demonstrate software to a prospective client. As shown in FIG. 10, at a first step (301) a potential client may visit a company's website 400. The client in this example will be accessing the website 400 via their end user device, the viewing device 50, which can be a desktop computer, laptop, tablet, smartphone, etc. When a viewing device 50 views the website 400 (see FIG. 11A-12B) employing a multiplatform screen sharing system 10, the website 400 at a second step 302 will display a prompt 405 (see FIG. 11A-12B) upon the website 400 which offers the end user a software demonstration. If the user wishes to view this software demonstration, they are first required to enter contact information for themselves (step 303) (see FIGS. 13A-14B). The requirement to enter contact information acts as a screening process which enables sales staff to screen potential clients and also cuts down on the work a salesperson must do by having the end user enter their own contact information into a logging/reporting database 30 (see FIG. 1).

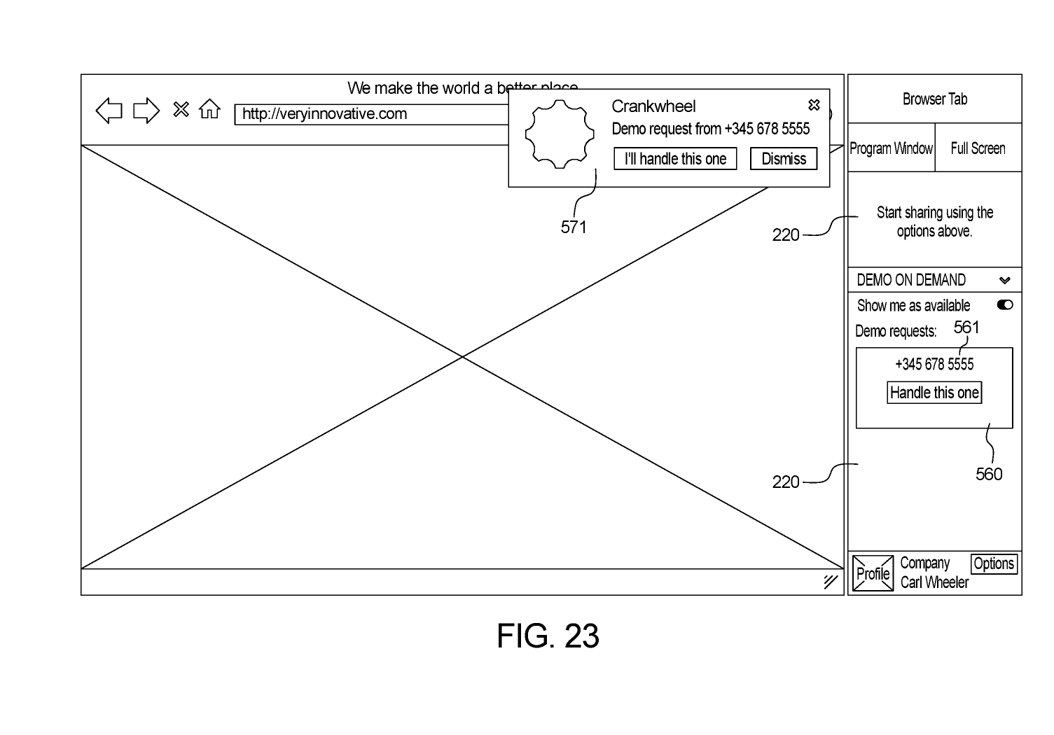

Once a prospective client enters at least some contact information, the system 10 may then create a unique session identifier for this end user and place them into a waiting queue 260 (see FIG. 8) of other unique session identifiers (step 304) (see FIG. 23). The system 10 will then notify the sales staff via email, SMS, pop-up message (see FIG. 23), etc. that there is a prospective client awaiting a software demonstration (step 305). A member of the sales staff can then select the prospective client's contact information from the waiting queue 260 (step 306) and initiate a screen sharing session 100 (step 307) wherein the salesperson's computer, tablet, etc. is the host device 40 (and the prospective client's computing device is the viewing device 50).

Alternatively, if system 10 determines there is no sales staff available (e.g., afterhours, etc.) or the wait time is excessive (step 308) the system 10 may instead play a demonstration video (step 309) for the prospective client instead of a live screen sharing session 100. The information collected from the prospective client can then be used to contact that user at a later time, with the multiplatform screen sharing system 10 capable of generating URL session links 223 etc. to send to the end user to start a screen sharing session 100.

FIG. 11A is a hosted website 400 of a company utilizing a multiplatform screen sharing system 10 to prompt 405 prospective clients with an offer for a software demonstration upon the client's desktop computer. As shown in FIG. 11A, the hosted website 400 may display within a viewing device's 50 web browser 401 a prompt 405, in this case a prompt button 410 which will open a contact information collection window 420 (see FIG. 13A-14B). The prompt button 410 in this example offers the prospective client the chance to view an instant software demo upon their viewing device 50 without the need to download any additional software, browser plugins, etc. The prompt button 410 may be embedded within the website's 400 content or displayed as an overlay upon it via JavaScript coding, etc. The prompt button's 410 text may also change depending on the availability of sales staff to prove a demo. For instance, if the system 10 detects a salesperson logged into the system 10, the prompt button 410 may read “Get an Instant Demo Now”. If, however no sales staff is available, the system 10 may display a button which says “Schedule a Demo Now” to prevent a potential client from waiting for an unavailable instant demo and becoming dissatisfied.

It should be noted that each of the pop-up windows, etc. displayed to the viewing device 50 may be coded into the website of a given company or displayed as an overlay upon the website's content via JavaScript or any other web programming language.

FIG. 11B is a hosted website 400 of a company utilizing a multiplatform screen sharing system 10 to display a prompt 405 to prospective clients with an offer for a software demonstration upon the client's mobile device. As shown in FIG. 11B, it is full imagined that the viewing device 50 may be either a desktop computer or mobile computing device (e.g., smartphone). It should be noted that the present system 10 can deduce via cookie data, etc. what type of device is being utilized as the viewing device 50 to enable the presenter to better demonstrate software to the prospective client. For example, if the viewing device 50 is a smartphone, the host device 40 likely wants to show either a mobile device version of the software for sale or show a view of the desktop software which is appropriately formatted for a mobile device; both of which can be done automatically by the system 10.

FIG. 12A is a website 400 of a company utilizing a multiplatform screen sharing system 10 to display an alternative prompt 405 to prospective clients with an offer for a software demonstration. As shown in FIG. 12A, an alternative to the prompt button 410 (FIG. 11A) is a pop-up prompt 415 which may automatically pop-up the prompt 405 for a software demonstration in the bottom corner of a company's website 400. The pop-up prompt 405 may be set to display only after the prospective client has lingered on the website 400 for a certain amount of time. Similar to the prompt button shown in FIG. 12A, the text of the pop-up prompt 415 may be altered depending on real time sales staff availability.

FIG. 12B is a hosted website 400 of a company utilizing a multiplatform screen sharing system 10 to display a pop-up prompt 415 to prospective clients with an offer for a software demonstration upon a mobile device. As shown in FIG. 12B, like FIG. 11B, the system 10 may detect the type of viewing device 50 being utilized by a client and display to them an appropriately formatted pop-up prompt 415 as well as a properly formatted software demonstration screen sharing session 100.

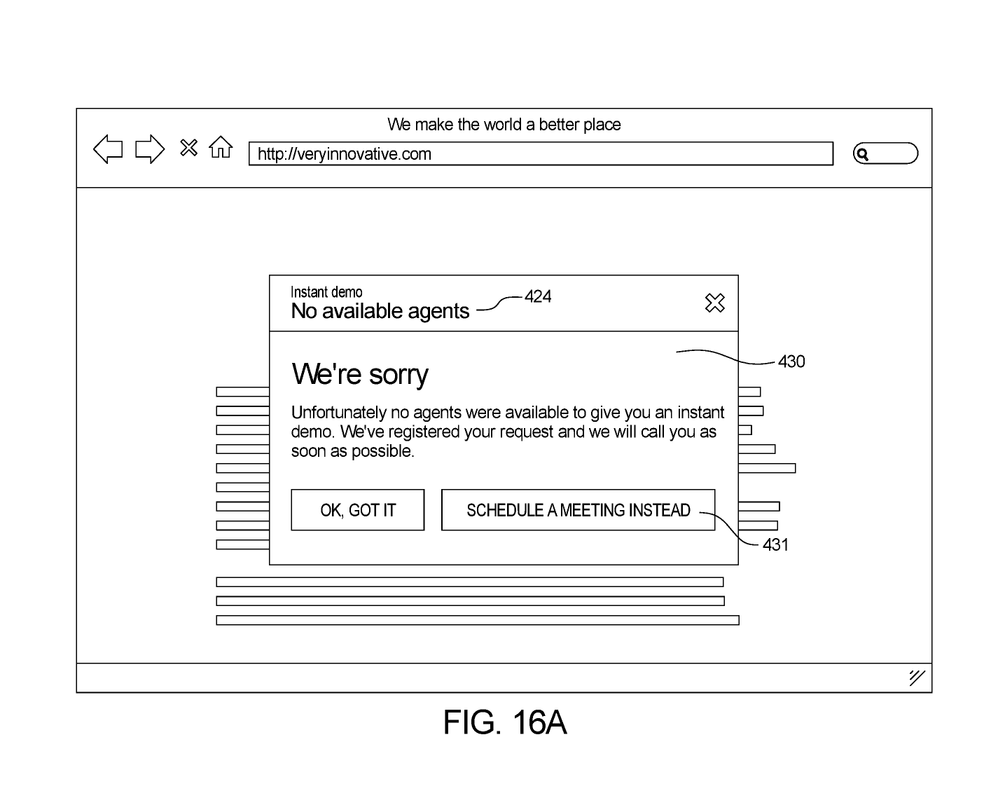

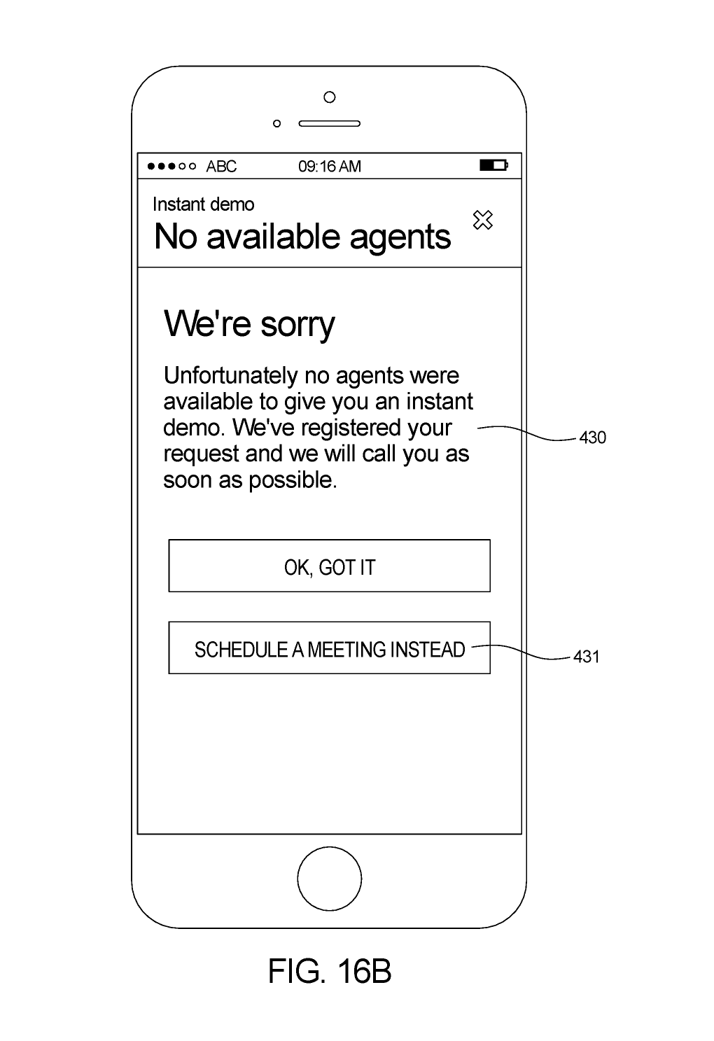

FIG. 13A is a contact information collection window 420 displayed upon a website 400 generated by a multiplatform screen sharing system 10. As shown in FIG. 13A, the multiplatform screen sharing system 10 may require the entrance of contact information in order to place a request for a screen sharing session 100. This is done to prevent viewing devices 50 from spamming such requests and enables sales staff to confirm the legitimacy of a request before taking time to carry out a screen sharing session 100. The contact information collection window 420 may be overlaid upon the website 400 content or linked to as a separate webpage. In this example, the contact information collection window 420 is displayed via HTML, CSS, and/or JavaScript (or another programming language capable of generating animated visual displays) and requires the prospective client, via their viewing device 50 to enter their phone number to request an instant software demonstration. The phone number is collected by a data entry field 421 and submitted via a submission button 422. Once the prospective client enters their phone number, the system 10 then automatically creates and associates a session identifier with the given client's contact information and places the session identifier in a waiting queue 260 (see FIG. 23). When a sales person is ready, they can, via their viewing device 50 begin a screen sharing session 100 via this unique session identifier. A status indicator 424 is also displayed which, in some embodiments, determines a real time estimate of the wait time for a live software demonstration (see FIG. 16A).

FIG. 13B is a contact information collection window 420 displayed upon a website 400 generated by a multiplatform screen sharing system 10 upon a mobile device. As shown in FIG. 13B, the contact information collection window 420 may be displayed upon a mobile viewing device 50 in a manner which is best formatted for that device 50 rather it be a smartphone, tablet, or other computing device.

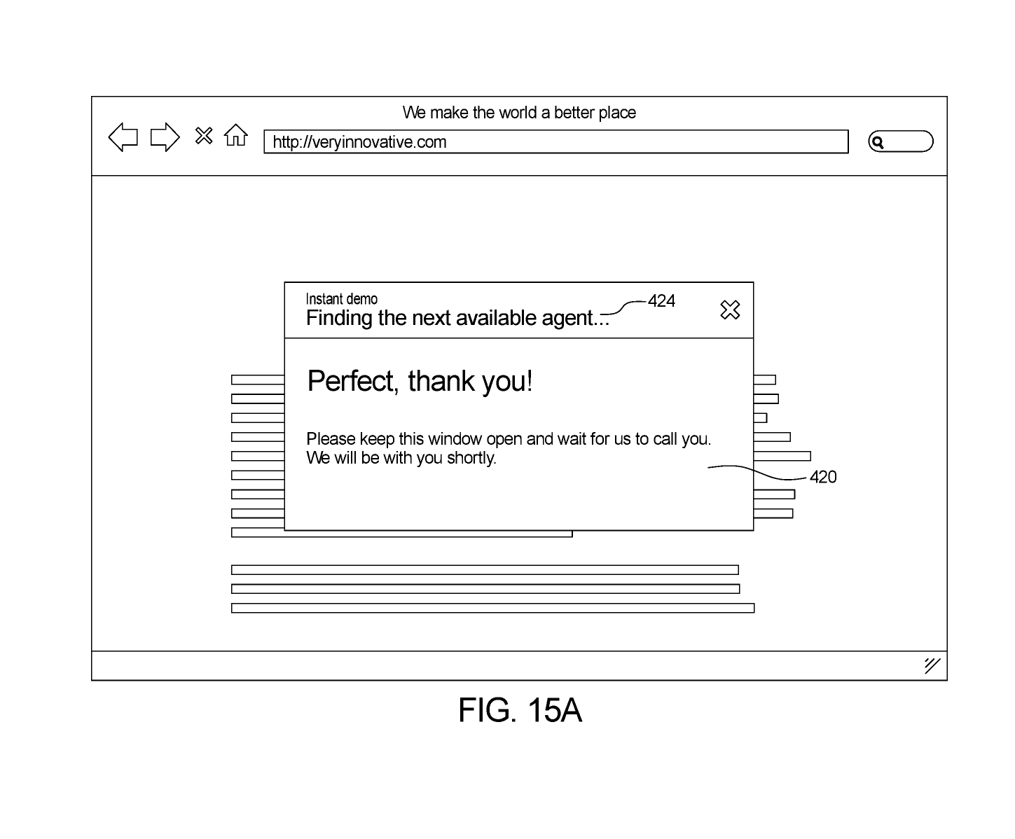

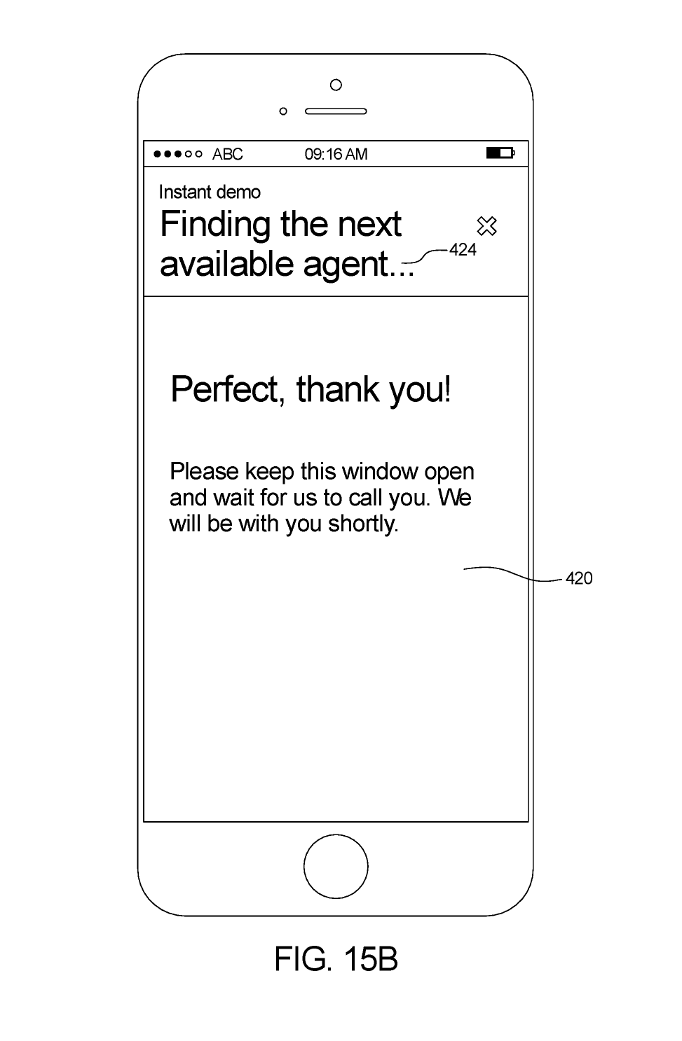

FIG. 14A is a contact information collection window 420 displayed upon a website 400 collecting optional contact information. As shown in FIG. 13A, once a potential client enters their phone number (in this example) the system 10 will then prompt the user to enter other helpful pieces of contact information. Such contact information can include the potential client's name, job title, mailing address, email address, etc. All of this information is collected in a series of data entry fields 421 which can also be free response fields, drop down menus, radio buttons, etc. While the potential client is entering this optional information via the data entry fields 421 and submission button 422 (or skipping entry of such data via the skip button 423) a status indicator 424 is displayed within the contact information collection window 420. The status indicator 424 may provide real time updates to the prospective client about the status of their request for a software demonstration. The status indicator 424 shown in FIG. 15A displays a status of “Finding Next Available Agent” but can also provide to the viewing device 50 information such as a time estimate (e.g., “An agent will be with you in 3 minutes”) or the potential client's place in the waiting queue 260 (e.g., “There are 5 people ahead of you”).

FIG. 14B is a contact information collection window 420 displayed upon a website 400 collecting optional contact information on a mobile device. As shown in FIG. 14B, the functionality discussed as part of FIG. 14A may also be utilized on mobile viewing devices 50 and formatted properly in such cases.

FIG. 15A is a contact information collection window 420 displaying a status indicator 424. As shown in FIG. 15A, when all of the optional contact information data entry fields 421 have been filled in and submitted by a potential client (or skipped) the contact information collection window 420 will remain open and continue to display (and update) the status indicator 424.

FIG. 15B is a contact information collection window 420 displaying a status indicator 424 on a mobile device. As shown in FIG. 15B, the status indicator 424 will continue to display and update the real time status of available sales agents after an end user has completed entering their contact information.

FIG. 16A is a scheduling window 430 displayed in response to no available sales staff being logged in to conduct a screen sharing session 100. As shown in FIG. 16A, the contact information collection window 420 may transform into a scheduling window 430 if there are no sales staff available to provide a potential client a software demonstration via screen sharing session 100. In this example, the scheduling window 430 displays a status indicator 424 which states “No Available Agents”. This indicator 424 could also read “Wait Time is over 30 minutes” or another message with more detail regarding why there are no agents presently available. In keeping with one of the main advantages of the present system 10; instantaneous client engagement, the scheduling window 430 enables a prospective client to schedule a time with an agent via the scheduling button 431.

The determination of whether or not there are any available sales agents can be carried out by the system 10 assessing each sales staff member's calendar (via integration with Google Calendar, Outlook, etc.) and can also include keyboard/mouse usage upon the host device(s) 40 to determine if a sales agent is actually physically present at their computer to give a sales demonstration.

The schedule button 431 may present a data entry field in which the prospective client can enter their requested meeting time. Alternatively, some embodiments of the multiplatform screen sharing system 10 may enable the potential client, via their viewing device 50 to access a virtual calendar of one or more sales agents to actually schedule a time upon the agent's calendar. Such a scheduling request may be facilitated by integration of the multiplatform screen sharing system 10 with various scheduling software platforms, CRM platforms, etc. Integration with a CRM system for example, could automatically create a sales lead entry and scheduling information within the CRM for each potential client that requests a demo via a webhook or other functional piece of computer code which would enable such an integration.

One example of such an integration would be with Google Calendar or another user-friendly scheduling software. When the prospective client who wishes to schedule a meeting clinks the scheduling button 431 they will be directed to a webpage which features the schedules of one or more sales agents with available booking times listed. The prospective client can then choose one of the times, with the multiplatform screen sharing system's 10 integration with the scheduling software enabling reception of this information and recording it in the logging/reporting database 30 as well as sending email, SMS, and other types of reminders to the selected sales agent and prospective client.

In another embodiment, companies may alternatively decide to embed a list of all agents (whether available or not) on a web page, within an email, etc. In this case, the prospect could choose a desired agent, and then depending on whether they are immediately available or not, request an instant demo or request to book a demo in the future as discussed above.

When the time comes to conduct this scheduled meeting, the multiplatform screen sharing system 10 may generate a URL session link 223 and then email or text this link 223, which the potential client can then click on and be brought to a live screen sharing session 100. Verification of the viewing device 50 may be carried out by the system 10 displaying to the viewing device 50 user a unique two-digit number which is also displayed to the host device 40 user. This enables the host device 40 user to ask the prospective client what their verification number is and for the host device 40 user enter this number into the GUI 220 at which point the given screen sharing session 100 will be verified and connected in a similar manner to that discussed in FIG. 8′s description.

The system 10 may generate URL session links 223 which have the ability to grant instant access when the corresponding screen sharing session 100 is active and then require verification (as discussed above) if a viewing device 50 user clicks the link 223 before or after the session 100 has ended. This is done by storing all the links 223 generated by the system 10 in one or more databases 30, the links 223 including one or more parameters (e.g., link age, etc.) which enable the system 10 to determine if the link 223 is associated with a currently live screen sharing session 100. The parameters stored by the system 10 concerning the links 223 can also be stored separately within the database(s) 30 and referenced to determine if a link 223 is for an active screen sharing session 100.

It should be noted that any link 223, whether linked to an active session or not, can be marked as expired by a host device 40 user. This can be done on a settings page of the GUI 220 or after a certain number of connections are made by the system 10 based off viewing devices 50 utilizing the link 223. This means, for example, if someone is spamming a presenter by trying to connect to one of their links over and over, the presenter can expire the link 223 and not be bothered.

This ability to send out a URL session link 223 which enables potential clients to access a live screen sharing session 100 can also be utilized as part of a mass emailing marketing campaign. For example, some embodiments of the multiplatform screen sharing system 10 employed by large scale software sales operations may collect emails and other contact information for a large number of clients. If there are a large number of interested potential clients, the ability for sales staff to readily address all requests for software demonstration in real-time may be extremely difficult thus the collection of contact information upfront and then emailing out links 223 to live software demonstration sessions 100 based off availability of sales staff is invaluable.

Such availability may be predicted by the system 10 based off such factors as: how many sales emails have been opened so far (tracked using a typical 1×1 pixel image or invisible image in the email); the historical (from other campaigns) rates of going from opening an email to clicking on the request for software demonstration in a certain number of minutes; the historical user response rates; historical rates of potential clients going from entering their phone number and requesting a demo to actually picking up the phone and attending an instant demo; the number of agents allocated to the pool, and the number of agents currently showing as available; the typical length of demo as indicated in the campaign setup; the actual length of demo as indicated by previous demos in the current campaign. The aspects listed above would allow the system 10 to determine an appropriate rate of sending sales emails, so that the pool of agents can be utilized as efficiently as possible, without exceeding the maximum number of software demonstration requests which could actually be handled by an organization.

FIG. 16B is a scheduling window 430 displayed in response to no available sales staff being available to conduct a screen sharing session 100 on a mobile device. As shown in FIG. 16B, a potential client may still schedule a meeting via the schedule button 431 but the system 10 may, in some embodiments, display a scheduling website which is optimized for mobile. Alternatively, the system 10, detecting that the viewing device 50 is a cell phone, etc. may instead email the potential client a link to enable them to schedule a time to speak with a salesperson. This email can then be accessed when the potential client is on a desktop computer or laptop when scheduling, etc. can be more easily carried out. Such functionality enables the system to collect the end user's information a single time and not require the potential client to enter it again when actually scheduling a meeting.

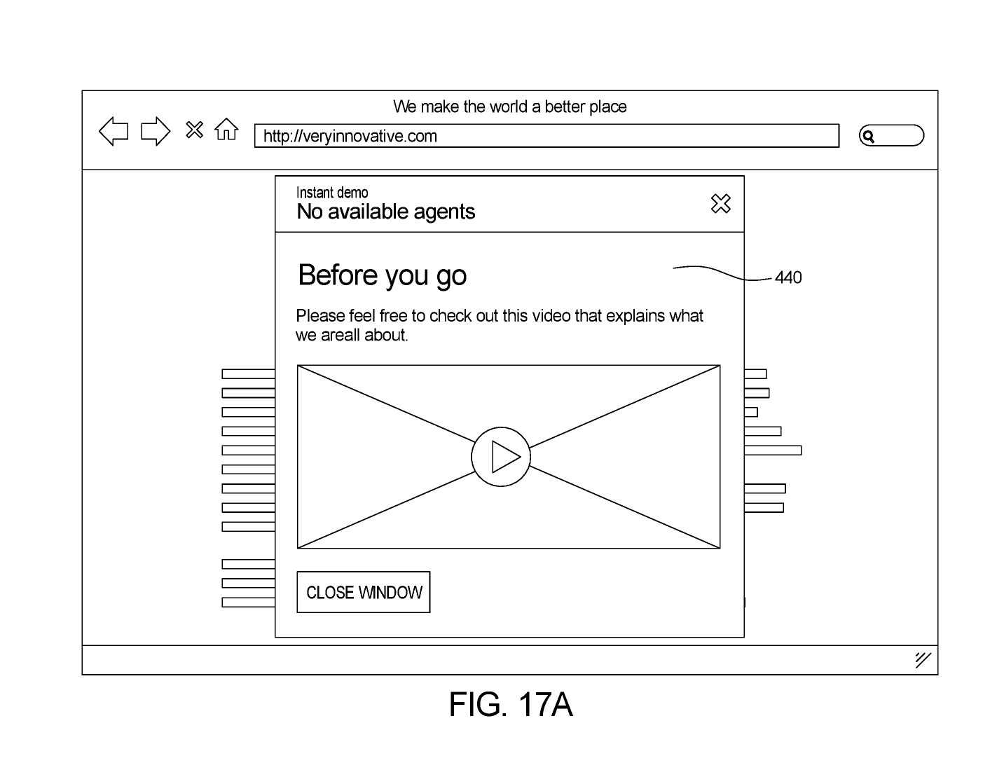

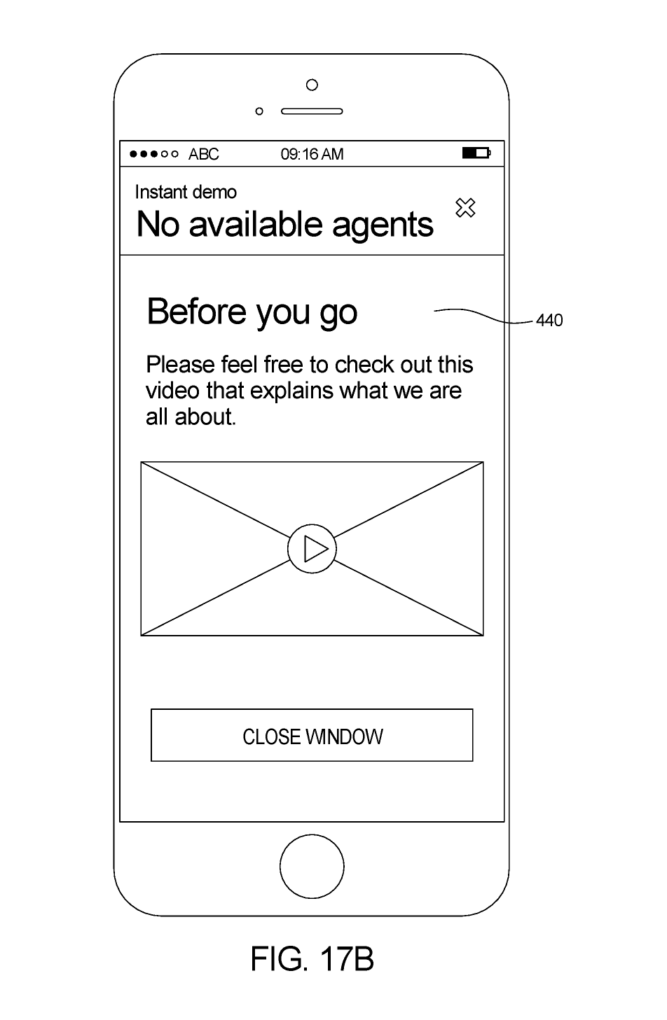

FIG. 17A is a video demonstration window 440 displayed in response to no sales staff being available to conduct a screen sharing session 100. As shown in FIG. 17A, if no sales staff is available to provide a software demonstration via screen sharing session 100, the multiplatform screen sharing system 10 may display an imbedded, prerecorded video 441 for end users. This video 441 may also only be displayed after the potential client enters some, or all, of the requested contact information to prevent spam or other illicit activity.

FIG. 17B is a video demonstration window 440 displayed in response to no available sales staff being available to conduct a screen sharing session 100 on a mobile device. As shown in FIG. 17B, the video demonstration window 440 and video imbedded therein may be formatted for mobile devices automatically by the system 10.

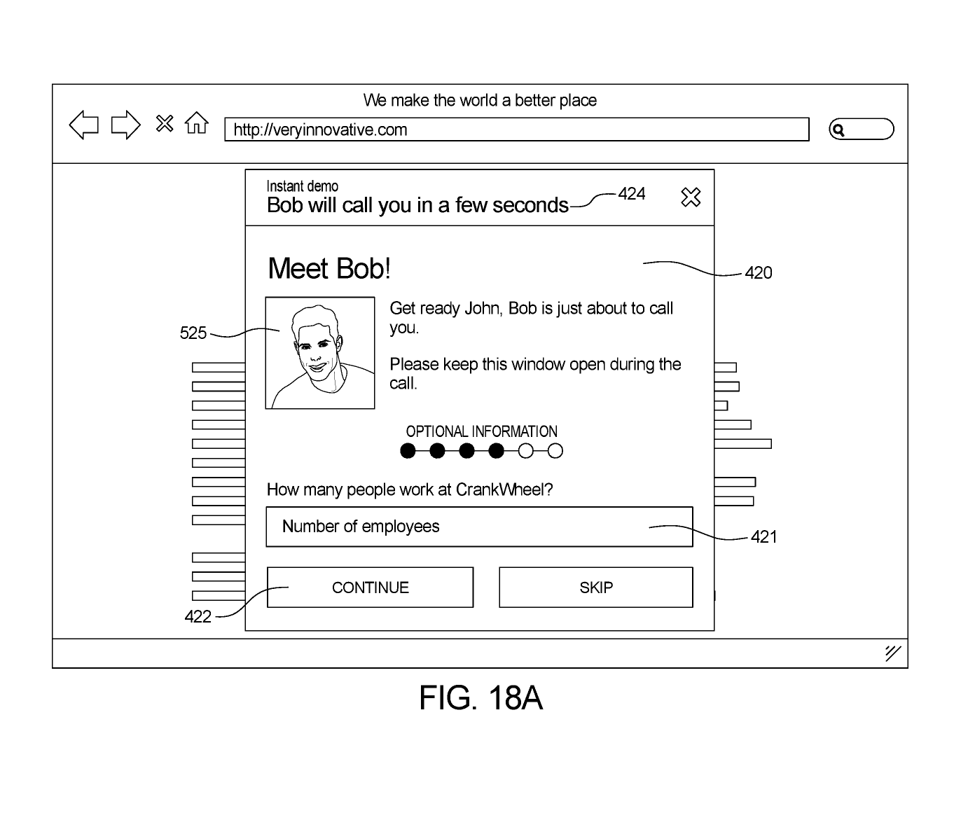

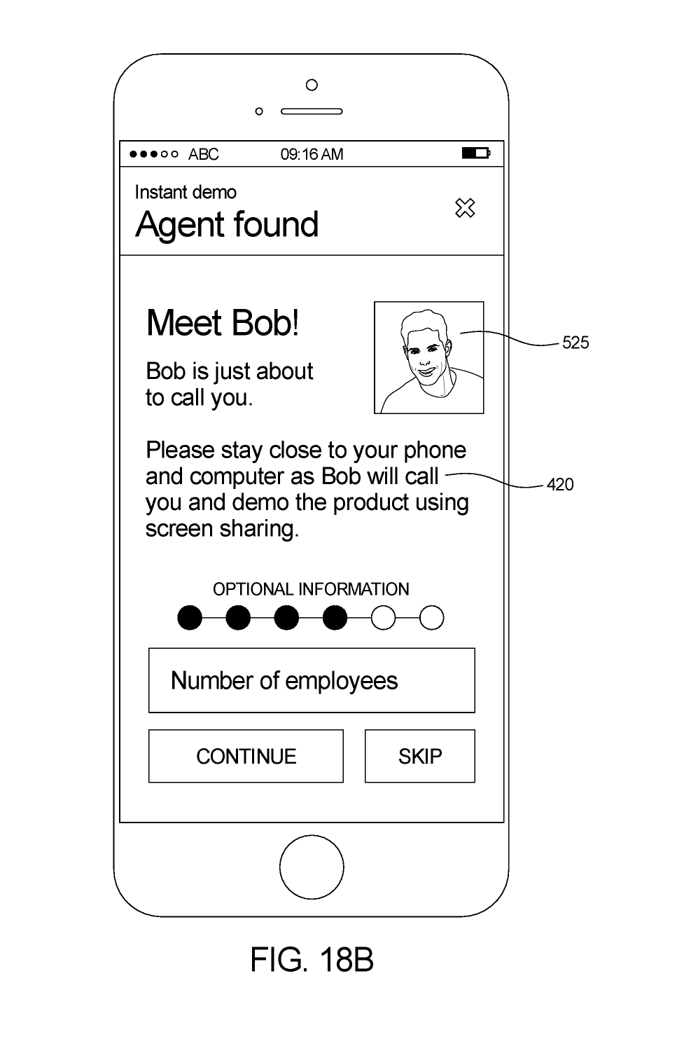

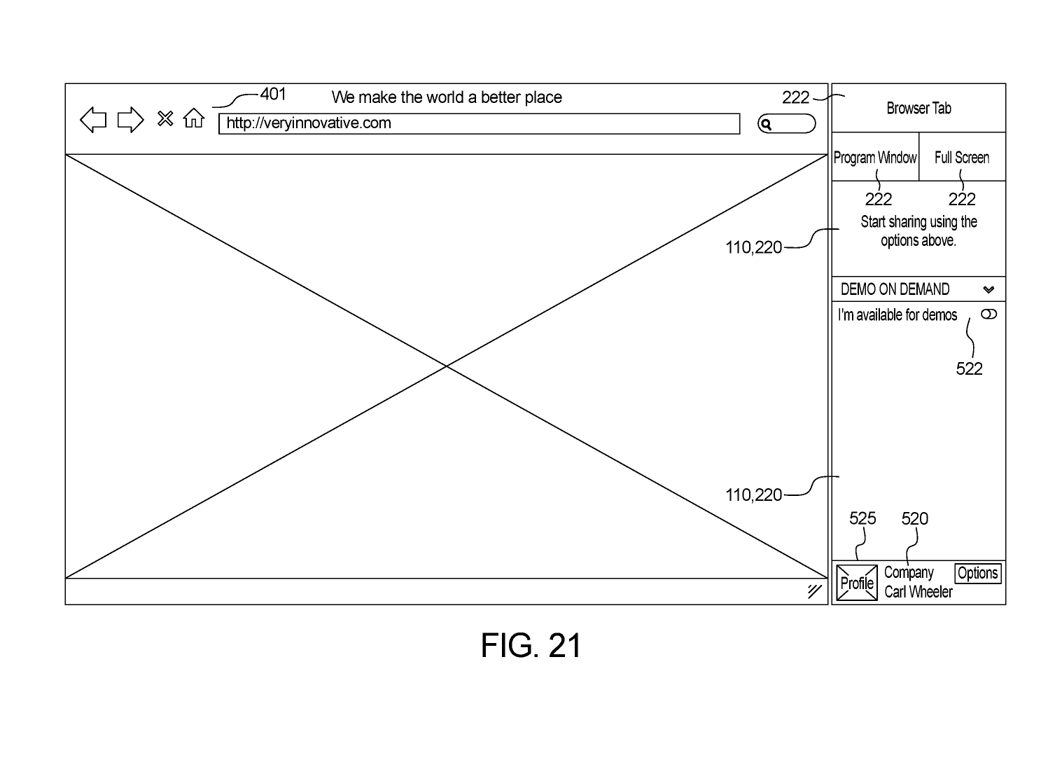

FIG. 18A is a contact information collection window 420 after a sales agent has selected a potential client's session identifier from the waiting queue 260. As show in FIG. 18A, the contact information collection window 420 may be updated once a sales agent selects the session identifier from the waiting queue 260 (see FIG. 23) created by the multiplatform screen sharing system 10. The contact information collection window 420 enables a potential client to continue to enter their contact information into the data entry fields 421 while they wait in the waiting queue 260. The status indicator 424 will display information such as “Agent Found” or “Agent will call you shortly” along with displaying a profile picture 525 which is associated with a given sales person's profile 520 (see FIG. 21).

Sales staff members can configure their profile 520 to also include details about their working hours. For instance, if a given sales agent works from 9 AM-5 PM Monday-Friday, the system 10 may only enable prospective clients to request a software demonstration during these hours. Other calendar data (including meetings which can be skipped, interrupted, etc.) can be can also be accounted for by the system 10 including data from Google Calendars, a vCal feed, etc. This enables the system 10 to schedule software demonstration times more efficiently as well as provide to prospective clients an accurate estimate of waiting times, etc.

FIG. 18B is a contact information collection window 420 displayed on a mobile device after a sales agent has selected a potential client's session identifier from the waiting queue 260. As shown in FIG. 18B, the contact information collection window 420 may be updated in a similar manner as discussed in FIG. 18B with the window 420 being formatted to fit a mobile device and the sales person's profile picture 525, etc. displayed.

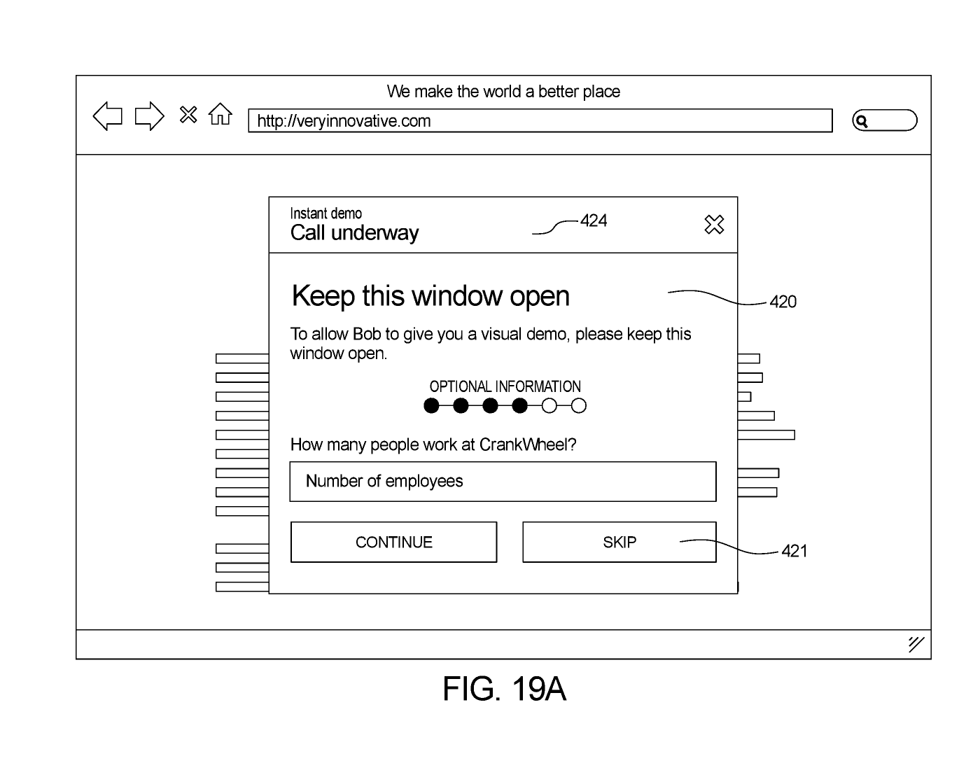

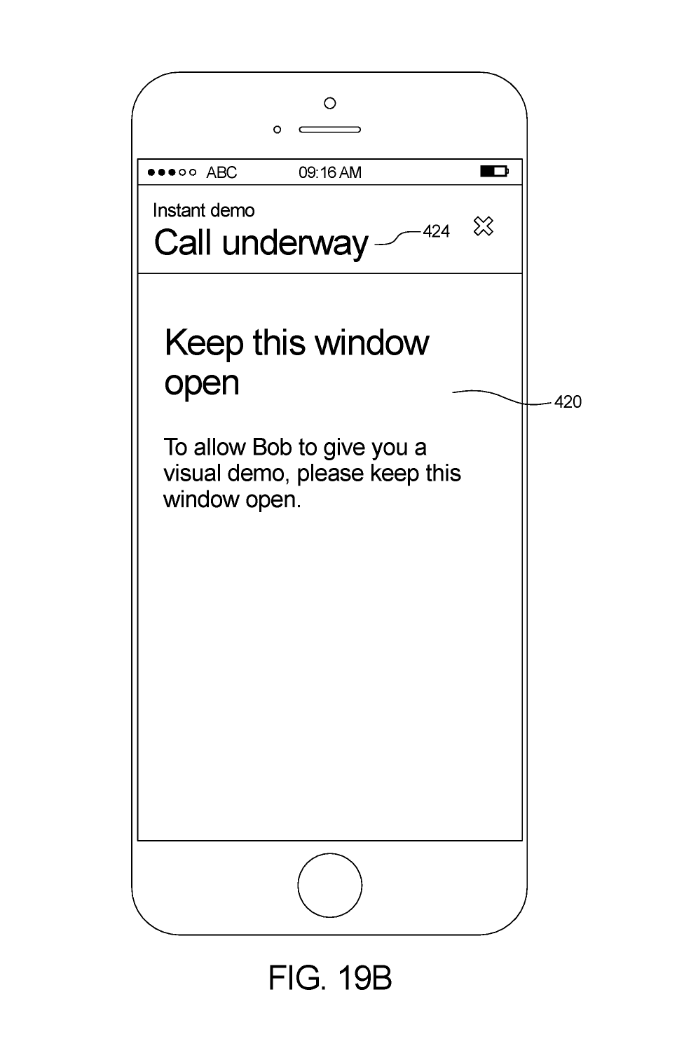

FIG. 19A is a contact information collection window 420 after a sales agent has started a demonstration call with a potential client. As shown here, since the contact information collection window 420 is overlaid upon the website 400 of a given company, once a sales call begins, the contact information collection window 420 may remain open to enable the potential client to continue to enter their contact information into the various data entry fields 421. This information will then be added to the record(s) created for this potential client, with the unique session identifier also associated with such records. These records may be stored in the logging and reporting database(s) 30.

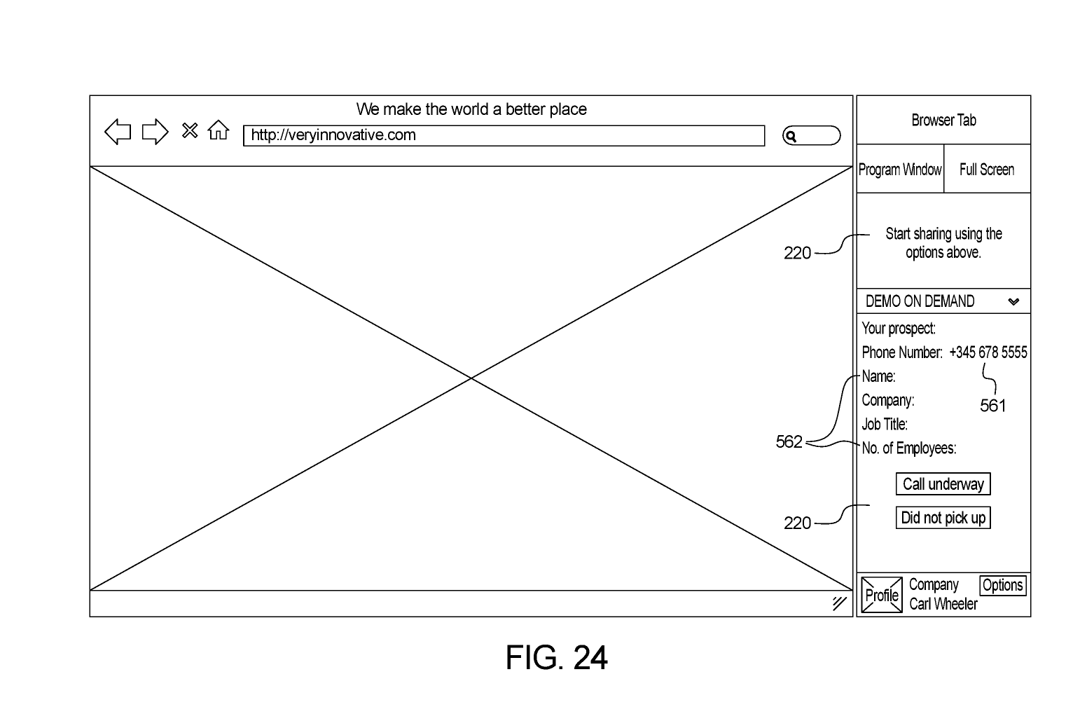

Through integration with VoIP services, the multiplatform screen sharing system 10 can enable sales staff to call the phone number provided by a potential client from the system's 10 GUI 220 (see FIG. 24). This integration also enables the status indicator 424 to update a potential client and let them know when a sales person has called them with a message that reads “Call Underway”, etc.

FIG. 19B is a contact information collection window 420 displaying a status indicator 424 after a sales agent has started a demonstration call with a potential client. Similar to what is shown in FIGS. 15A-15B, if a potential client enters all their contact information (or skips doing so) the system 10 may display for them a status indicator 424 which lets them know how their request is progressing. In this example, the sales person has called the potential client (confirmed by VoIP integration) but not yet started a screen sharing session 100. Live video chat built on WebRTC, etc. as well as a text-based chat system (that is live right away, even before a potential client starts entering their phone number, etc.) could also be integrated into the multiplatform screen sharing system 10 via JavaScript, etc. depending on the level of interactivity sought by a given company.

If communication (in the form of text chat, video chat, etc.) is initiated by the system 10 prior to entry of any contact information by an end user, the system 10 may begin by allocating a unique session identifier to the real-time connection with the one or more system 10 servers (one or more physical servers 20 and/or virtual servers 26, see FIG. 1). This unique session identifier and any additional information such as associated contact information, the chat log, etc. will then be recorded by the system 10 within the logging/reporting database(s) 30.

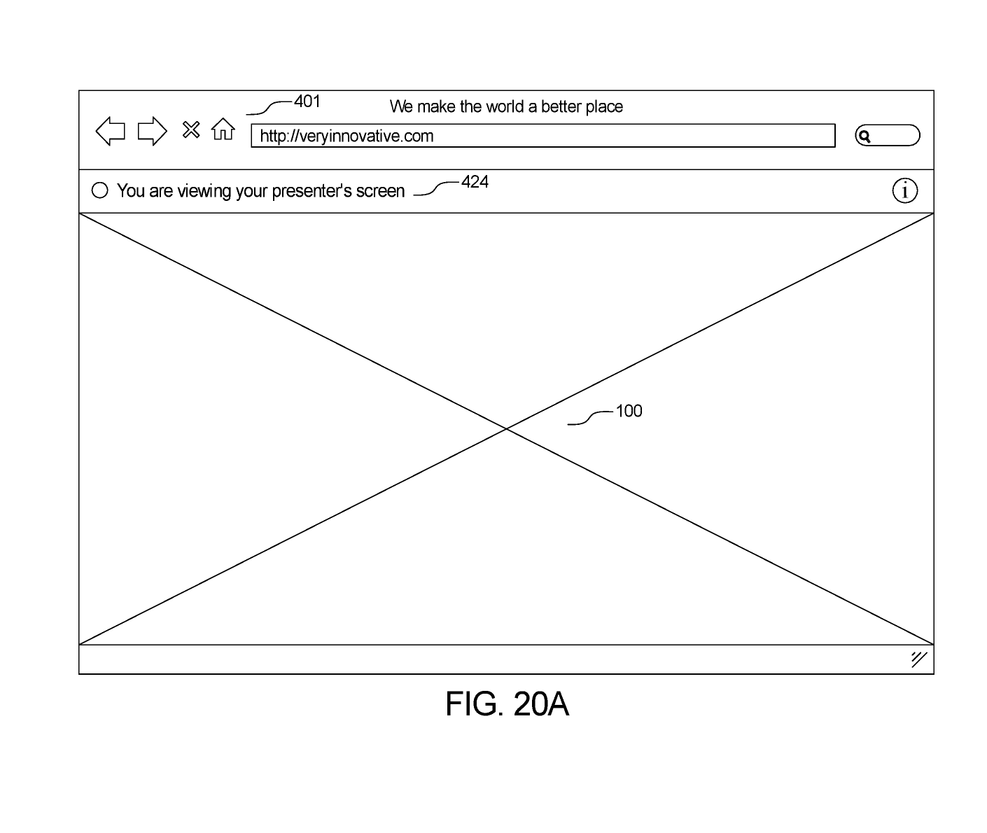

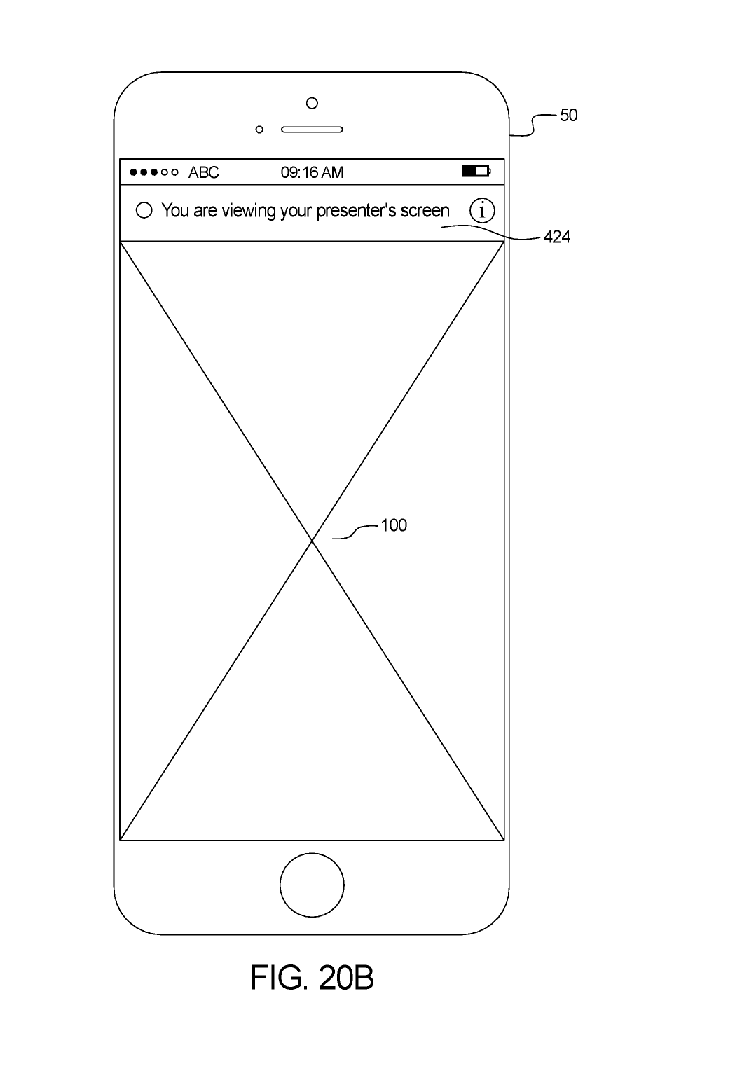

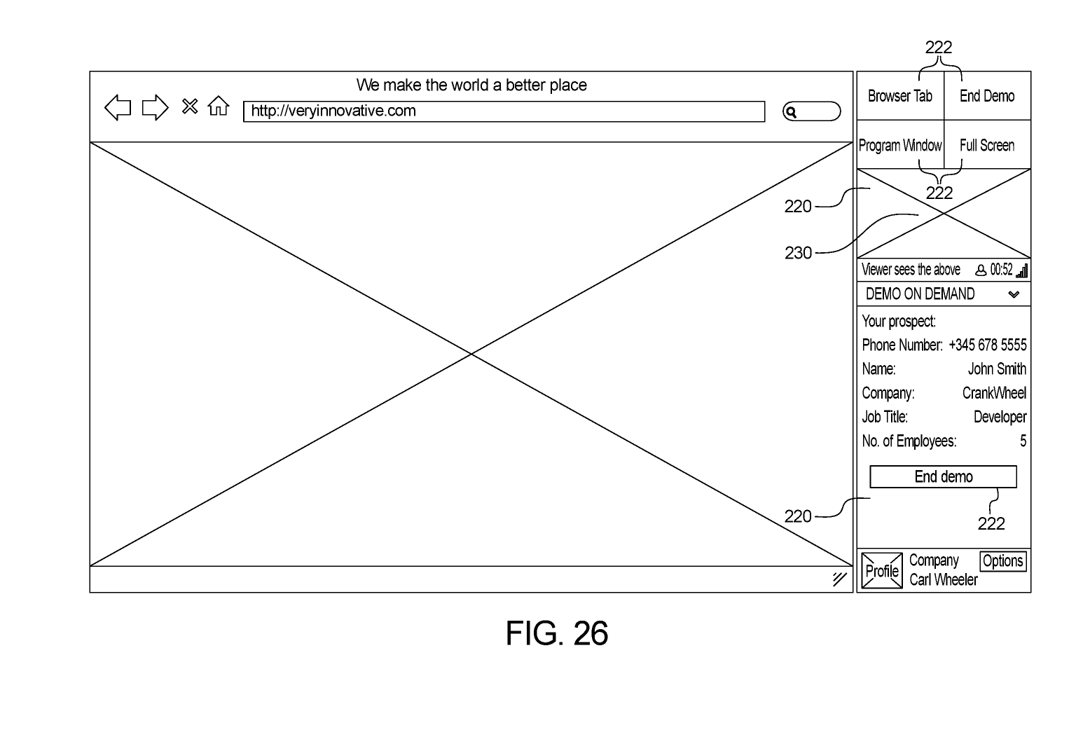

FIG. 20A is a viewing device 50 displaying a screen sharing session 100. As shown in FIG. 20A, once the host device 40 begins a screen sharing session 100 (see FIG. 26), the shared program window or desktop (or portion thereof) of the host device 40 will be displayed upon the webpage 400 the viewing device 50 has open within its web browser 401. The screen sharing session 100 generated by the multiplatform screen sharing system 10 requires no additional software to be installed upon the viewing device 50 (see FIG. 6); providing the ability to provide an almost instantaneous live software demonstration. The status indicator 424 continues to display, with the updated message “You are viewing the presenter's screen” displayed to inform the viewer of such information.

FIG. 20B is a viewing device 50 displaying a screen sharing session 100 on a mobile device. As shown in FIG. 20A, once the host device 40 begins a screen sharing session 100 (see FIG. 26), the shared program window or desktop (or portion thereof) of the host device 40 will be displayed upon the webpage 400 the viewing device 50 has open within its web browser 401. It should be noted that in some embodiments of the multiplatform screen sharing solution, the host device 40 used for presenting a software demonstration may be a desktop or laptop while the viewing device 50 is a smartphone or tablet. As these devices have different display sizes, aspect ratios, etc. the system 10 may inform the presenter (upon the host device 40) of the type of viewing device 50 being presented to (see FIG. 26). The system 10 may also adjust the visual elements contained in the screen sharing session 100 to optimize them for display on the viewing device 50.

For example, if a database program is being demonstrated, the database tables may be very difficult to read upon a mobile viewing device 50 as the display of a smartphone, etc. is much smaller than a desktop computer. Accordingly, instead of displaying the entire desktop or program window upon the mobile viewing device, the system 10 may show the active portion of the host device's 40 shared screen to make viewing easier.

FIG. 21 is a screen of a web browser 401 with a browser extension 110 of the multiplatform screen sharing system 10 installed. As shown in FIG. 21, a host user device 40 may install a browser add-on extension 110 that installs a graphical user interface 220 (GUI) that enables users to host screen sharing sessions on the system 10 (see FIG. 3). As mentioned previously, each sales staff member who utilizes the multiplatform screen sharing system 10 may be required to first create a log-in to access the system 10. This login may be linked to a profile 520. This profile 520 may have a profile picture 525 associated with it, the profile picture 525 and other profile details being displayed by the GUI 220 after log-in. The profile picture 525 and name associated with the prole 520 may also be displayed to prospective clients upon initiating a screen sharing session 100 (see FIG. 21).

The GUI 220 may also display command buttons 222 capable of initiating a screen sharing session 100. The buttons 222 allow a host user device 40 to share the current tab being viewed within a web browser 401, another program window, or the full screen of the host user device 40. The GUI 220 shown in FIG. 21 also features a demo on demand toggle 522. The demo on demand toggle 522 indicates to the system 10 whether a given host user, once logged into their respective profile, is ready to start providing screen sharing sessions 100 to prospective clients (viewing devices 50).

When a host user device is ready to begin presenting, they click the demo on demand toggle 522 to indicate they are ready to give live demos. At this point, a visual queue list 560 becomes populated (see FIG. 23) with unique session identifiers of viewing devices 50 of potential clients awaiting a live software demonstration. If no sales staff of a given company has indicated via the demo on demand toggle 522 that they are ready to begin hosting screen sharing sessions 100, the system 10 may indicate to potential clients that live demos are currently unavailable (see FIG. 16A).

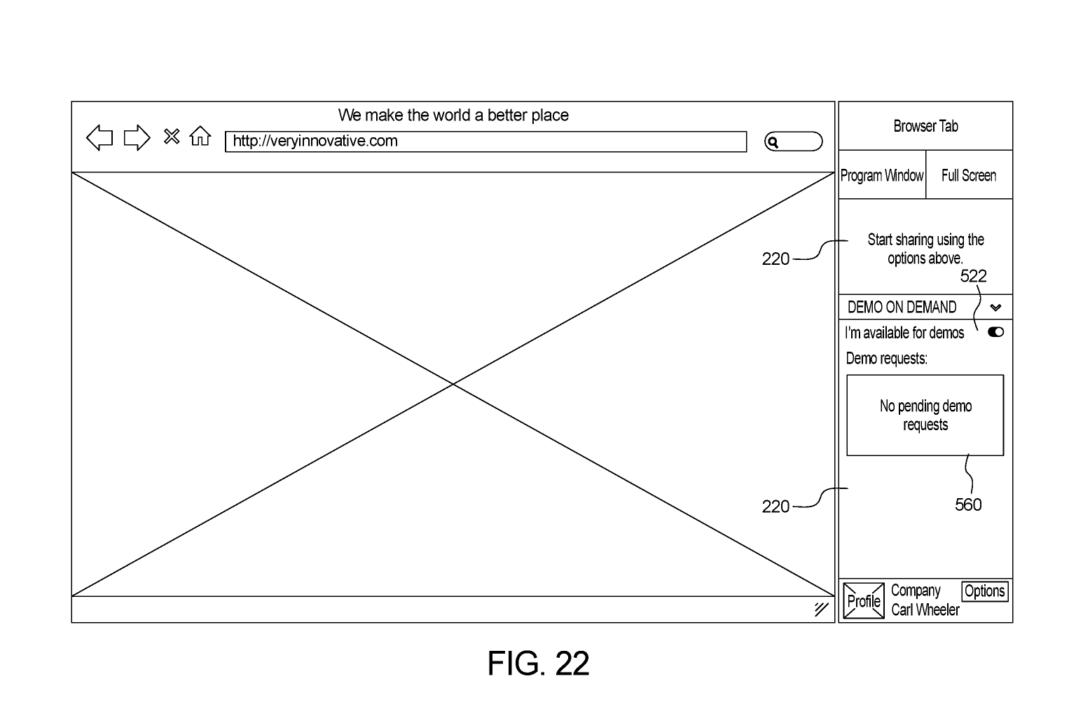

FIG. 22 is a screen of a GUI 220 of a host device 40 when the waiting queue 260 for screen sharing sessions 100 is empty. As shown in FIG. 22, the visual queue list 560 is empty as there are currently no viewing devices 50 awaiting a screen sharing session 100. The visual queue list 560 is updated in real time based off the waiting queue 260 after a host device 40 user indicates they are available via the demo on demand toggle 522.

FIG. 23 is a screen of a GUI 220 of a host device 40 when the waiting queue 260 is populated. As shown in FIG. 23, when a request for a live demo is received by the multiplatform screen sharing solution 10 from a viewing device 50, one or more hosting device(s) 50 are notified via the GUI 220. In the example shown, there is a request for a software demonstration via screen sharing session 100 received from a viewing device 50. This viewing device 50 is operated by a potential client, the client having the phone number “354-847-1045”. This phone number is used to visually represent the unique session identifier assigned to the request for a screen sharing session 100 by the system 10. The unique session identifier's visual representation 561 is displayed in the visual queue list 560 and in a pop-up notification 570. Notice of such a request can also be sent by the system via email, SMS, text message, etc.

If a given host device user 40 wishes to address a request for live software demonstration they can, via the GUI 220, select the unique session identifier's visual representation 561. Once selected, the unique session identifier's visual representation 561 will also be removed from the visual queue list 560 (as well as the actual waiting queue 260). When a host device user 40 selects a unique session identifier's visual representation 561 in order to provide a software demonstration, the unique session identifier's visual representation 561 will be removed from the visual queue list 560 for all host device users 40 (e.g., other sales agents) of a given organization. When a sales agent begins providing the live software demonstration to a given potential client the system 10 can also generate a notification message to other sales staff and managers. For instance, a sales team manager may opt to have the system 10 inform him/her of each live software demonstration given via email, text, or GUI 220 notification.

FIG. 24 is a screen of a GUI 220 of a host device 40 preparing to provide a live software demonstration. As shown in FIG. 24, once a unique session identifier's visual representation 561 has been selected by the user of a host device 40 from the visual queue list 560, contact details 562 concerning the prospective client will be displayed by the GUI 220. The contact details 562 can include the optional contact information provided by the user of the viewing device 50 and may be populated in real-time as the viewing device 50 user continues to enter their contact information post host device 40 selection.

The multiplatform screen sharing system 10 may also notify the prospective client (who's unique session identifier's visual representation 561 was selected by the host device 40 user) that their screen sharing session 100 is about to begin. Such information is relayed, in one example, via the status indicator 424 (see FIG. 18A).

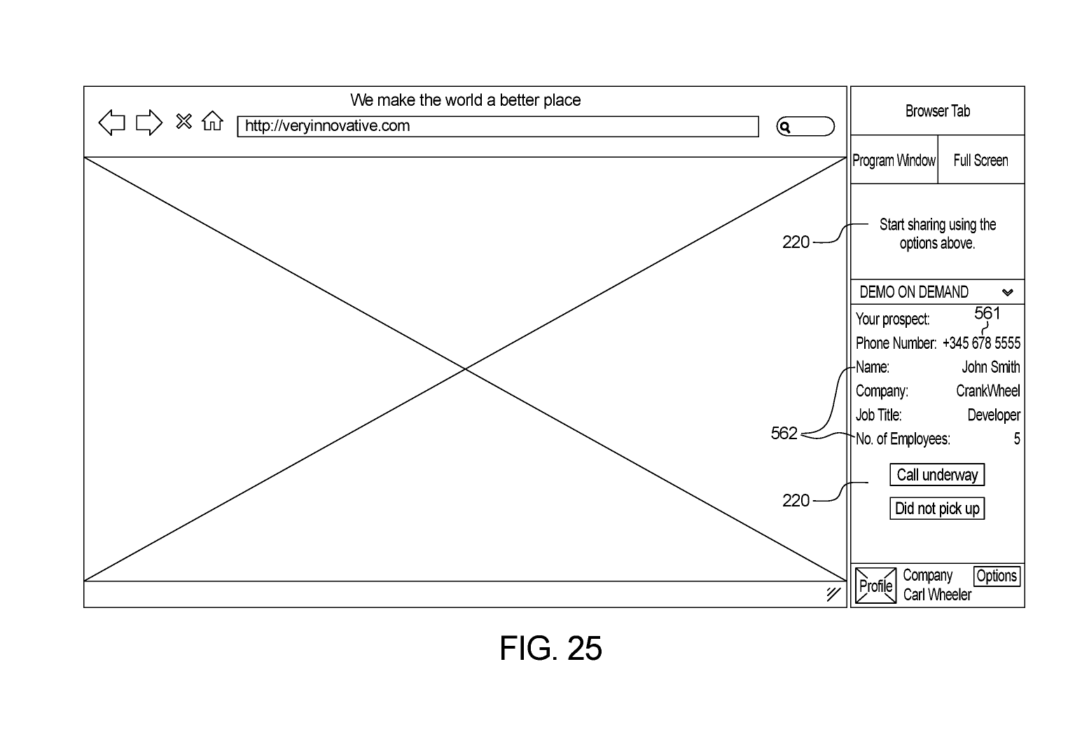

FIG. 25 is a screen of a GUI 220 displaying real time updated contact details 562 of a viewing device 50 user. As shown in FIG. 24, even after a unique session identifier's visual representation 561 has been selected by the user of a host device 40 from the visual queue list 560, contact details 562 may continue to be entered. Entrance of such information may be done by the host 40 or viewing 50 device users. For example, if a potential client gives only their phone number, the sales staff member can call the number provided and while speaking to them on the phone, update the contact details 562 associated with the given phone number in real time as this information is acquired. Alternatively, the user of the viewing device 50 may also enter this information themselves via the contact information collection window 420 (see FIG. 18A). All the contact details 562 collected by the system 10 will be stored in the reporting/logging database 30 for report generation, etc.

Also shown in FIG. 25, the host device 40 user may manually indicate the status of the telephone call placed to begin contact with the client (e.g., prior to initiating the screen sharing session). Such information is useful for reporting purposes and may also be automatically noted via VoIP integration. This information regarding whether a call has been placed to the client or not can also be communicated to the client in real time via the status indicator 424 (see FIG. 18A).

FIG. 26 is a screen of the GUI 220 of a host device 40 conducting a screen sharing session 100. As shown in FIG. 26, once a screen sharing session 100 is initiated, a preview panel 230 is generated which reflects what the viewer device 50 currently displays on their end. The preview panel 230 is ultimately displaying a part or whole of the screen of the host device 40 back to the host device 40 so this user (a sales staff member) can ensure the potential client is following along. In this example, the host device 40 user has selected to share only their current browser tab with the viewing device 50 via the corresponding command button 222. Once a screen sharing session is initiated, another command button 222 may appear on the host device's 40 GUI 220 which enables the host device 40 user to end the screen sharing session 100.

The preview panel 230 shows the size and location of the customer's viewport 240 (see FIG. 5) (i.e., which part of the video/image stream being sent to the viewer device 50 the viewer is currently seeing in their browser window, on the screen of their mobile device, etc. (see FIG. 20A-20B)). If the viewer zooms in or out, or scrolls their viewport 240 around, these updates are reflected in the preview panel 230. The system 10 may also automatically adjust or re-adjust the viewport 240 of the viewing device to best view the software demonstration. Once a screen sharing session has ended, the system 10 may automatically generate and email a sales brochure, a report of information shared in the session 100, etc. to the potential client.

The system 10 may also generate reports based off integration with CRM systems. Such reports can provide a list of new potential clients to a salesperson for easy review at the end of the day. Reports generated by the present system 10 may also include statistical information regarding the number of software demo requests received a day, the average duration of such a demonstration, the number of screen sharing sessions which also included a phone call, etc. All of this information may be aggregated by the system 10 for all user profiles 520 associated with a given organization to give management an idea of what sales tactics and demonstration methods are preferred by a company's actual consumers.

It should be noted that various changes and modifications to the presently preferred embodiments described herein will be apparent to those skilled in the art. Such changes and modifications may be made without departing from the spirit and scope of the present invention and without diminishing its attendant advantages.

1. A method of providing on-demand, live, presenter hosted, product or service demonstrations via the internet comprising the steps of:
providing a server including memory in communication with a processor, the memory including instructions that when executed by the processor cause the server to:
present a product or service to a user of a first device through a website provided by the server;
prompt the user to request an on-demand, live, presenter hosted, product or service demonstration, the prompt including a request for user contact information;
in response to receiving the user contact information from the first device, associate the first device with the request for the on-demand, live, presenter hosted, product or service demonstration and generates a unique session identification associated with the request for the on-demand, live, presenter hosted, product or service demonstration;
place the unique session identification in a queue of one or more active unique session identifications;
notify one or more presenter devices of the one or more active unique session identifications; and
when one or more presenters are available to provide the requested on-demand, live, presenter hosted, product or service demonstration, provide the requested on-demand, live, presenter hosted, product or service demonstration through a screen sharing system facilitated by the website provided by the server; and
when none of the one or more presenters are available to provide the requested on-demand, live, presenter hosted, product or service demonstration, providing access to a pre-produced demonstration video to the first device.

2. The method of claim 1, wherein the step of providing a pre-produced demonstration video to the first device further comprises a step of requesting scheduling of a live, presenter hosted, product demonstration.

3. The method of claim 1, wherein when none of the one or more presenters are available to provide the requested on-demand, live, presenter hosted, product or service demonstration, the server provides the first device real-time data regarding the availability of the requested on-demand, live, presenter hosted, product or service demonstration and an approximate wait time.

4. The method of claim 1, wherein the step of prompting the user to request an on-demand, live, presenter hosted, product or service demonstration, the prompt including a request for user contact information, includes contacting the user through a batch contact process wherein the batch contact rate is dependent on the real-time availability of the on-demand, live, presenter hosted, product or service demonstration.

5. The method of claim 1, wherein the user contact information is an email address.

6. The method of claim 1, wherein the first device is a mobile device.

7. The method of claim 1, wherein the screen sharing system comprises:
a host device including a host device processor, a host device memory, a host device visual data output device, and a host device communication subsystem, wherein the host device memory includes instructions that when executed by the host device processor cause the host device to perform the ascribed actions;
one or more viewer devices, including the first device, each viewer device including a viewer device processor, a viewer device memory, a viewer device visual data output device, and a viewer device communication subsystem, wherein the viewer device memory includes instructions that when executed by the viewer device processor cause the viewer device to perform the ascribed actions; and
one or more central server devices, including the server, each central server device including a central server processor and a central server memory, wherein the central server memory includes instructions that when executed by the central server processor cause the central server to perform the ascribed actions;
two or more reflection server devices, each reflection server device including a reflection server processor and a reflection server memory, wherein the reflection server memory includes instructions that when executed by the reflection server processor cause the reflection server to perform the ascribed actions;
wherein, in response to receiving a request to host a visual data sharing session from the host device to share visual data with the one or more viewer devices, the one or more central servers:
selects a one of the two or more reflection servers to serve as a selected reflection server for the visual data sharing session;
generates a unique URL for the one or more viewer devices to access the visual data sharing session via the reflection server;
in response to one or more of the viewer devices accessing the URL, establishes a communication connection between the host device and the one or more viewer devices; and
transmits visual data captured on the host device to the one or more viewer devices.

8. The method of claim 1, wherein the screen sharing system comprises:
a host device including a host device processor, a host device memory, a host device visual data output device, and a host device communication subsystem, wherein the host device memory includes instructions that when executed by the host device processor cause the host device to perform the ascribed actions;
one or more viewer devices, including the first device, each viewer device including a viewer device processor, a viewer device memory, a viewer device visual data output device, and a viewer device communication subsystem, wherein the viewer device memory includes instructions that when executed by the viewer device processor cause the viewer device to perform the ascribed actions; and
one or more central server devices, including the server, each central server device including a central server processor and a central server memory, wherein the central server memory includes instructions that when executed by the central server processor cause the central server to perform the ascribed actions;
two or more reflection server devices, each reflection server device including a reflection server processor and a reflection server memory, wherein the reflection server memory includes instructions that when executed by the reflection server processor cause the reflection server to perform the ascribed actions;
wherein, in response to receiving a request to host a visual data sharing session from the host device to share visual data with the one or more viewer devices, the one or more central servers:
selects a one of the two or more reflection servers to serve as a selected reflection server for the visual data sharing session;
establishes a communication connection between the host device and the one or more viewer devices; and
transmits visual data captured on the host device to the one or more viewer devices.

9. An on-demand, live, presenter hosted, system for presenting product or service demonstrations via the internet comprising:
a server including memory in communication with a processor, the memory including instructions that when executed by the processor cause the server to:
present a product or service to a user of a first device through a website provided by the server;
prompt the user to request an on-demand, live, presenter hosted, product or service demonstration, the prompt including a request for user contact information;
in response to receiving the user contact information from the first device, associate the first device with the request for the on-demand, live, presenter hosted, product or service demonstration and generates a unique session identification associated with the request for the on-demand, live, presenter hosted, product or service demonstration;
place the unique session identification in a queue of one or more active unique session identifications;
notify one or more presenter devices of the one or more active unique session identifications; and
when one or more presenters are available to provide the requested on-demand, live, presenter hosted, product or service demonstration, provide the requested on-demand, live, presenter hosted, product or service demonstration through a screen sharing system facilitated by the website provided by the server; and
when none of the one or more presenters are available to provide the requested on-demand, live, presenter hosted, product or service demonstration, providing access to a pre-produced demonstration video to the first device.

10. The system of claim 9, wherein providing a pre-produced demonstration video to the first device further comprises requesting scheduling of a live, presenter hosted, product demonstration.

11. The system of claim 9, wherein when none of the one or more presenters are available to provide the requested on-demand, live, presenter hosted, product or service demonstration, the server provides the first device real-time data regarding the availability of the requested on-demand, live, presenter hosted, product or service demonstration and an approximate wait time.

12. The system of claim 9, wherein prompting the user to request an on-demand, live, presenter hosted, product or service demonstration, the prompt including a request for user contact information, includes contacting the user through a batch contact process wherein the batch contact rate is dependent on the real-time availability of the on-demand, live, presenter hosted, product or service demonstration.

13. The method of claim 9, wherein the user contact information is an email address.

14. The method of claim 9, wherein the first device is a mobile device.

15. The method of claim 9, wherein the screen sharing system comprises:
a host device including a host device processor, a host device memory, a host device visual data output device, and a host device communication subsystem, wherein the host device memory includes instructions that when executed by the host device processor cause the host device to perform the ascribed actions;
one or more viewer devices, including the first device, each viewer device including a viewer device processor, a viewer device memory, a viewer device visual data output device, and a viewer device communication subsystem, wherein the viewer device memory includes instructions that when executed by the viewer device processor cause the viewer device to perform the ascribed actions; and
one or more central server devices, including the server, each central server device including a central server processor and a central server memory, wherein the central server memory includes instructions that when executed by the central server processor cause the central server to perform the ascribed actions;
two or more reflection server devices, each reflection server device including a reflection server processor and a reflection server memory, wherein the reflection server memory includes instructions that when executed by the reflection server processor cause the reflection server to perform the ascribed actions;
wherein, in response to receiving a request to host a visual data sharing session from the host device to share visual data with the one or more viewer devices, the one or more central servers:
selects a one of the two or more reflection servers to serve as a selected reflection server for the visual data sharing session;
generates a unique URL for the one or more viewer devices to access the visual data sharing session via the reflection server;
in response to one or more of the viewer devices accessing the URL, establishes a communication connection between the host device and the one or more viewer devices; and
transmits visual data captured on the host device to the one or more viewer devices.

16. The method of claim 9, wherein the screen sharing system comprises:
a host device including a host device processor, a host device memory, a host device visual data output device, and a host device communication subsystem, wherein the host device memory includes instructions that when executed by the host device processor cause the host device to perform the ascribed actions;
one or more viewer devices, including the first device, each viewer device including a viewer device processor, a viewer device memory, a viewer device visual data output device, and a viewer device communication subsystem, wherein the viewer device memory includes instructions that when executed by the viewer device processor cause the viewer device to perform the ascribed actions; and
one or more central server devices, including the server, each central server device including a central server processor and a central server memory, wherein the central server memory includes instructions that when executed by the central server processor cause the central server to perform the ascribed actions;
two or more reflection server devices, each reflection server device including a reflection server processor and a reflection server memory, wherein the reflection server memory includes instructions that when executed by the reflection server processor cause the reflection server to perform the ascribed actions;
wherein, in response to receiving a request to host a visual data sharing session from the host device to share visual data with the one or more viewer devices, the one or more central servers:
selects a one of the two or more reflection servers to serve as a selected reflection server for the visual data sharing session;
establishes a communication connection between the host device and the one or more viewer devices; and
transmits visual data captured on the host device to the one or more viewer devices.
